(19) United States
(12) Patent Application Publication
(10) Pub. No.: US 2007/0038505 A1
(43) Pub. Date: Feb. 15, 2007

(54) Method and Systems For Workforce Management

(75) Inventors: John Fayette Barnes IV, San Antonio, TX (US); Lauren Christian Harper, San Antonio, TX (US); Ian William David Clements, San Antonio, TX (US)

Correspondence Address: FULBRIGHT & JAWORSKI L.L.P., 600 CONGRESS AVE., SUITE 2400, AUSTIN, TX, 78701, US

(73) Assignee: iNQUATE Corporation

(21) Appl. No.: 11/457,346

(22) Filed: Jul. 13, 2006

Related U.S. Application Data
(60) Provisional application No. 60/698,868, filed on Jul. 13, 2005.

(51) Int. Cl. H04M 3/51; G06F 11/34

(52) U.S. Cl. 705/11

(57) ABSTRACT

Methods and systems for integrating functions of human capital resource management pursuant to workforce development and maintenance are provided. A plurality of modules may be provided, and those modules may, amongst other things, establish corporate goals and individual employee objectives; establish and maintain the workforce population (workforce analysis); define and maintain workforce position descriptions; compare, determine, and/or maintain compensations factors (e.g., base salary and bonuses); coordinate recruiting efforts; analyze and document employees' performances, and develop succession plains and training objectives.

This application claims priority to, and incorporates by reference, U.S. Provisional Patent Application Ser. No. 60/698,868, filed Jul. 13, 2005.

### BACKGROUND OF THE INVENTION

1. Field of the Invention

The present invention relates generally to managing human capital assets. In particular, the present invention provides, amongst other things, budget and goals development cycles and facilitates building and maintaining a workforce.

2. Description of Related Art

Corporations around the world are faced with the management of personnel that sometimes span across the globe. Management software has been developed to aid in this process. Despite advances in management software, room for significant improvement remains. For example, current management software is specifically targeted for certain applications such as budgeting, goals and objectives, recruitment, and the like. It would be beneficial for integrating each of these individual products to better manage all aspects of a corporation. It would also be advantageous if user-friendly applets or graphical user interfaces are provided that would allow for efficient use and data capturing. Accordingly, a significant need exists for certain techniques described and claimed in this disclosure, which involve various improvements to the current state of the art.

Any shortcoming mentioned above is not intended to be exhaustive, but rather is among many that tends to impair the effectiveness of previously known techniques for managing human capital assets; however, shortcomings mentioned here are sufficient to demonstrate that the methodologies appearing in the art have not been satisfactory and that a significant need exists for the techniques described and claimed in this disclosure.

### SUMMARY OF THE INVENTION

Other features and associated advantages will become apparent with reference to the following detailed description of specific embodiments in connection with the accompanying drawings.

In one respect, the present disclosure provides a method for coordinating business functions of a company. The method may provide a plurality of modules including a goals and objective module, a workforce analysis module, a job description module, a compensation module, a recruiting module, a performance management module, and/or a succession planning and training module. The method may provide all of these modules or may include a combination of a few of these modules. For example, the method may provide a goals and objective module, a job description module, and a performance management module. Alternatively, the method may provide a goals and objective module, a performance management module, and a succession planning and training module. Or, the method may provide a compensation module, a workforce analysis module, and a recruiting module. Other combinations of some of the modules provided by the method would be recognized by one with ordinary skill in the art.

For each of the above modules, the method may provide a display, e.g., via an applet or a graphical user interface with input prompts. In some respects, the goals and objectives module may be configured to establish and share goals and objectives of the company. The workforce analysis module may be configured to determine a headcount and cost of personnel within the company. The job description module may be configured to determine personnel job descriptions and requirements. The compensation module may be configured to determine compensation factors. The recruiting module may be configured to coordinate recruiting efforts. The performance management module may be configured to analyze employee performance. The succession planning and training module may be configured to develop an employee training plan.

In some respects, a program storage device readable by a machine such as, but not limited to, a computer, a laptop, a handhold device, or other suitable computing devices known in the art may be used to perform the method. The program storage device may store a program of instructions executable by the machine to perform the method.

The disclosure provides data management techniques in at least two primary areas: strategic planning and operational implementation of the workforce including cost and performance. In one respect, the disclosure supports the development, management, and strategic guidance of a workforce through the establishment of corporate goals and individual employee objectives for a particular time period, e.g., the current and following year, determining and budgeting the number of incumbents in each position necessary to accomplish the goals, describing the job functions of each job, determining the cost of the workforce reflective of the workforce budget while comparing the internal labor market to the external labor market, assisting in the coordination of the recruiting process, automating the performance management process, and assisting in the implementation of succession planning and development of training plans. The present disclosure is able to integrate these seven primary functions, combinations thereof, or additional functions.

In some respects, the disclosure allows managers and supervisors the ability to develop objectives in support of corporate goals and share the objectives with their subordinate employees. For example, supervisors are provided the ability to request new positions during a budgeting process in order to achieve the desired objectives. Managers and supervisors may develop position descriptions in support of the new or existing positions. Specific users within the company may use embodiments of this disclosure to compare internal to external salary data and report the variances with respect to each department and individual. Each supervisor may request a new position at any time including the budget process using this invention. The supervisor may then track the progress of his/her requisition. Each supervisor and each employee can use embodiments of this disclosure to quickly develop a complete performance appraisal relying on data contained in this disclosure.

Embodiments of this disclosure can share critical data via the integration of seven primary modules. Each of the seven modules is typically designed for a specific series of tasks, although some degree of overlap may be present.

According to another aspect of the disclosure, three supporting modules, two of which are available to select individuals who are assigned roles as application and/or module administrators may be provided.

According to a further aspect of the disclosure, a series of access rights, e.g., selective access to the module(s), may be included. Access rights may granted by an application administrator who in turn grants read/write access to one or more of twenty different access roles.

According to a further aspect of the disclosure, the application administrator may assume the role of a user through a process called “Impersonation.” Impersonation allows the module administrator the ability to work on behalf of the user at the user role.

According to yet a further aspect of the disclosure, supervisory employees, who are directly responsible for the employment (i.e., hiring and firing) of employees, may be able to comment, edit, change and overwrite information provided to the application's modules by the subordinate employee.

According to yet a further aspect of the disclosure, users, with appropriate rights, may have access to request and report on stored data via either a pre-formed report or an ad-hoc report process. The disclosure includes a process that may prohibit users from accessing information that contains confidential data such as, but not limited to, compensation, planned termination, and recruiting data.

According to yet a further aspect of the disclosure, each module may be supported by a process guide and a context guide. The context guide may provide information pursuant to the operation of the module. The process guide may provide the user with information about why and how a particular business methodology is followed.

According to yet a further aspect of the disclosure, each module may be utilized independently of the remaining six primary modules.

The modules of the present disclosure, coined “iNQUATE” modules M1 through M7 by the inventors, are a plurality of modules, in accordance with embodiments of the present disclosure. iNQUATE Goals & Objectives (M1), as defined and used in the disclosure, is a module that drives the development of company/corporate goals and objectives, typically but not necessarily throughout the organization, and includes the ability to monitor progress against key milestones and/or deliverables. The module shares data with iNQUATE Performance Management and is typically available to all employees. The module typically features a full ad-hoc reporting process.

iNQUATE Workforce Analysis (M2), as defined and used in this disclosure, is a module that allows managers to forecast and budget workforce personnel. Approval by a Module administrator and senior management or other supervisory employee can lock the budget. The module shares data with iNQUATE Recruiting and iNQUATE Compensation and is typically available to employees with supervisory responsibilities pursuant to the Security Roles.

iNQUATE Job Descriptions (M3), as defined and used in this disclosure, is a module that allows managers to describe their staff's positions on-line. Descriptions may be updated each time an appraisal is completed. Approval by a manager and a Module administrator locks the descriptions. The module shares data with iNQUATE Performance Management and iNQUATE Recruiting and is typically available to all employees with either read only or read/write access dependent upon their level of responsibility.

iNQUATE Compensation (M4), as defined and used in this disclosure, is a module that assists in the determination of the cost associated with each position. A Module administrator may compare the salary data for each position with external salary survey data. The module may also allow managers to recommend salary increases and bonus amounts. The module shares data with iNQUATE Recruiting and iNQUATE Workforce Analysis and is typically available to employees with supervisory responsibilities.

iNQUATE Recruiting (M5) as defined and used in this disclosure, is a module that organizes the recruiting process by sharing information with the hiring manager and the assigned recruiter, whether internal or external. Through the module, a Module administrator assigns costs to each position for budgeting purposes. The module may provide full reporting capabilities including variance reports. The module shares data with iNQUATE Job Descriptions and iNQUATE Workforce Analysis and is typically available to supervisory employees on a limited read-only basis.

iNQUATE Performance Management (M6), as defined and used in this disclosure, is a module automates the performance appraisal process. Each employee begins the appraisal process on his/her own. Doing so eliminates the need for manual input thus saving time and money. The module may also include a verbal and written corrective action recording process. The module shares data with iNQUATE Job Descriptions and iNQUATE Goals & Objectives and is typically available to all employees. The module typically features a full ad-hoc reporting process.

iNQUATE Succession Planning & Training (M7), as defined and used in this disclosure, is a module that assists in the development of succession plans by title which results in individualized training plans. The system provides ways to develop succession plans based on the stated educational and experience requirements as recorded in the iNQUATE Job Descriptions module. In addition, the succession planning portion incorporates data from iNQUATE Employee Administration, iNQUATE Goals & Objectives, and iNQUATE Performance Management. The module also provides a method of assimilating and reporting on training plans for each employee. The plan is based in part on a gap analysis that is produced as a result of the completion of a succession plan combined with required training based on position requirements and mastery of SOPs. The training plan is typically accessible by each employee personally. Once a training plan has been developed, it is integrated with iNQUATE Goals & Objectives and may display in the personal objectives section of Goals & Objectives. The module typically features a full ad-hoc reporting process.

In addition to the above modules, supporting administrative modules, including, for example, a user preferences module (EM), an employee administration module (UPM), and an application administration module (AM) may be provided, as shown in FIG. 2.

The user preferences module (EM), as defined and used in this disclosure, is a module that allows users to change their system-generated passwords, reject automatic emailing, and view the company's employee handbook as applicable. The employee administration module (UPM), as defined and used in this disclosure, is a module that allows select individuals the ability to update employee information or to import data from a legacy database as necessary. Data from the EM and the UPM as well as data from external sources may be provided to the application administration module. In some respect, data from external sources may include, without limitation, an accounting or legacy database that stores information relating to personnel of a corporation. In some embodiments, external data may include an employee's full name, employee ID number, annual salary, hire date, email ID, department and division. This information may be substantially up-to-date and stored in a matter for easy parsing, i.e., table link, so modules that require the external data may not obtain this data dynamically. Alternatively or in addition to the personnel data, the external data may include other information such as average salaries for similar positions, training programs, and the like that may be provided to the application administration module (AM).

The application administration module (AM), as defined and used in this disclosure, is a module that allows an application administrator the ability to at least impersonate other employee users (see FIG. 3), establish and administer department and division lists (see FIG. 4), list currency used in the application, organize and change images used in the application, administer user roles, and develop system messages for modules using, e.g., the information provided by an EM module, a UPM module, and external data.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one-non and in one non-limiting embodiment the substantially refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

### BRIEF DESCRIPTION OF THE DRAWINGS

The following drawings form part of the present specification and are included to further demonstrate certain aspects of the present invention. The figures are examples only. They do not limit the scope of the invention.

FIG. 1 shows a block diagram of iNQUATE modules, in accordance with embodiments of this disclosure.

FIG. 2 shows a block diagram of a plurality of modules, in accordance with embodiments of this disclosure.

FIG. 3 shows a graphical user interface of an application administration module, in accordance with embodiments of this disclosure.

FIG. 4 shows a graphical user interface of an application administration module, in accordance with embodiments of this disclosure.

FIG. 5 shows security roles for system users and administrator access roles, in accordance with embodiments of this disclosure.

FIG. 6 shows security roles for system users, in accordance with embodiments of this disclosure.

FIG. 7 shows a graphical user interface for determining roles of personnel, in accordance with embodiments of this disclosure.

FIG. 8 shows a flowchart of functions of a goals and objectives module, in accordance with embodiments of this disclosure.

FIGS. 9 through 20 are graphical user interfaces associated with steps shown in FIG. 8, in accordance with embodiments of this disclosure.

FIG. 21 shows a flowchart of functions of a workforce analysis module, in accordance with embodiments of this disclosure.

FIGS. 22 through 24 are graphical user interfaces associated with steps shown in FIG. 21, in accordance with embodiments of this disclosure.

FIG. 25 shows a flowchart of functions of a job description module, in accordance with embodiments of this disclosure.

FIGS. 26 through 34 are graphical user interfaces associated with steps shown in FIG. 25, in accordance with embodiments of this disclosure.

FIG. 35 shows a flowchart of functions of a compensation module, in accordance with embodiments of this disclosure.

FIGS. 36 through 41 are graphical user interfaces associated with steps shown in FIG. 35, in accordance with embodiments of this disclosure.

FIG. 42 shows a flowchart of functions of a recruiting module, in accordance with embodiments of this disclosure.

FIGS. 43 through 46 are graphical user interfaces associated with steps shown in FIG. 42, in accordance with embodiments of this disclosure.

FIG. 47 shows a flowchart of functions of a performance management module, in accordance with embodiments of this disclosure.

FIGS. 48 through 60 are graphical user interfaces associated with steps shown in FIG. 47, in accordance with embodiments of this disclosure.

FIG. 61 shows a flowchart of functions of a succession planning and training module, in accordance with embodiments of this disclosure.

FIGS. 62 and 63 are graphical user interfaces associated with steps shown in FIG. 61, in accordance with embodiments of this disclosure.

### DESCRIPTION OF ILLUSTRATIVE EMBODIMENTS

The disclosure and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

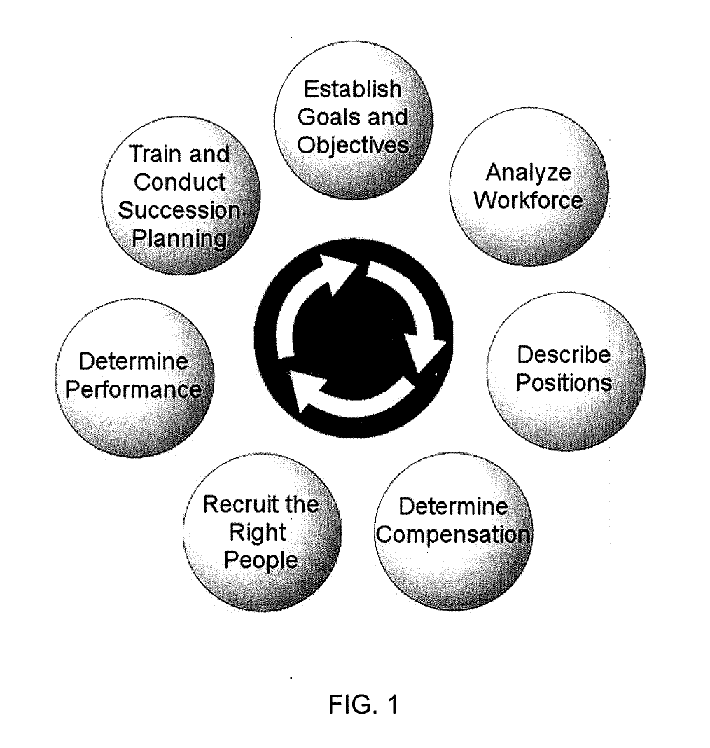

Modules of the present disclosure, M1 through M7, as shown in FIG. 1, may each integrate with one or more of the remaining user modules. In some embodiments, each module may be purchased and utilized separately by a client company and may be made operable by an enabling system key. Alternatively, every module M1 through M7 or some of the modules may be packaged together as an integral component.

The strategic and workforce management system of the present disclosure may be browser based utilizing Microsoft Internet Explorer or other suitable web browsers known in the art. Therefore, individuals corporate-wide, especially individuals of a corporation that span the globe, may be able to access up-to-date data from a central server at any time, thus, not requiring a minimum or maximum size of a corporation utilizing the system.

Additionally, the present disclosure provides an integration of multiple modules related to the workings of a corporation, and more particularly, various facets of managing personnel, including, without limitation, recruiting efforts, goals and objectives, workface analysis, compensation, performance management, and planning and training for some or all members of a corporation. Inputs relating to any of the above functions may be stored on either a client server or external servers that are accessible via, for example, wired or wireless network connections of via the Internet. Alternatively or in addition to the above, the input data may also be saved to a personal computer.

The system may also allow users the ability to record, edit, develop, and utilize data in the course of fulfilling their responsibilities as productive employees. Users may be assigned one or more of a variety of read/write/edit rights.

The present disclosure provides a series of roles assigned to users by an application administrator, and thus providing, amongst other things, normal and restricted access to the modules (i.e., modules M1 through M7). These roles reflect rights to access and write data. Additionally, the roles may be grouped into two main categories: user access roles and administrator access roles. These roles are described in more details below.

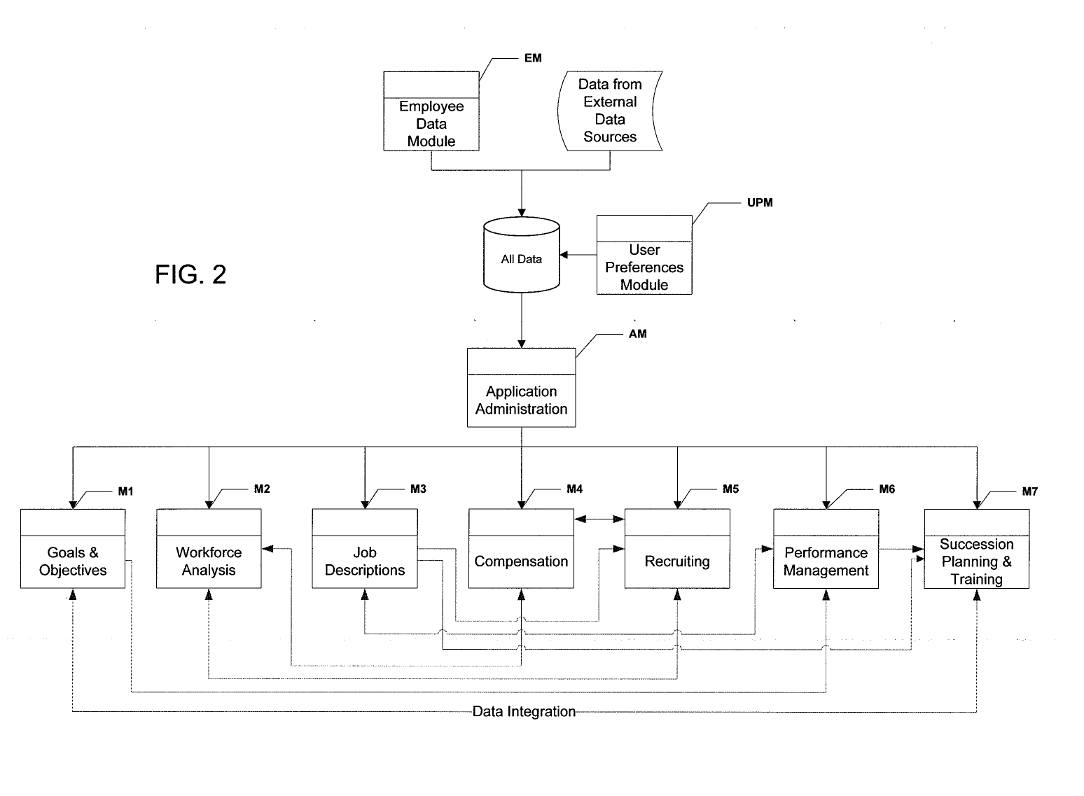

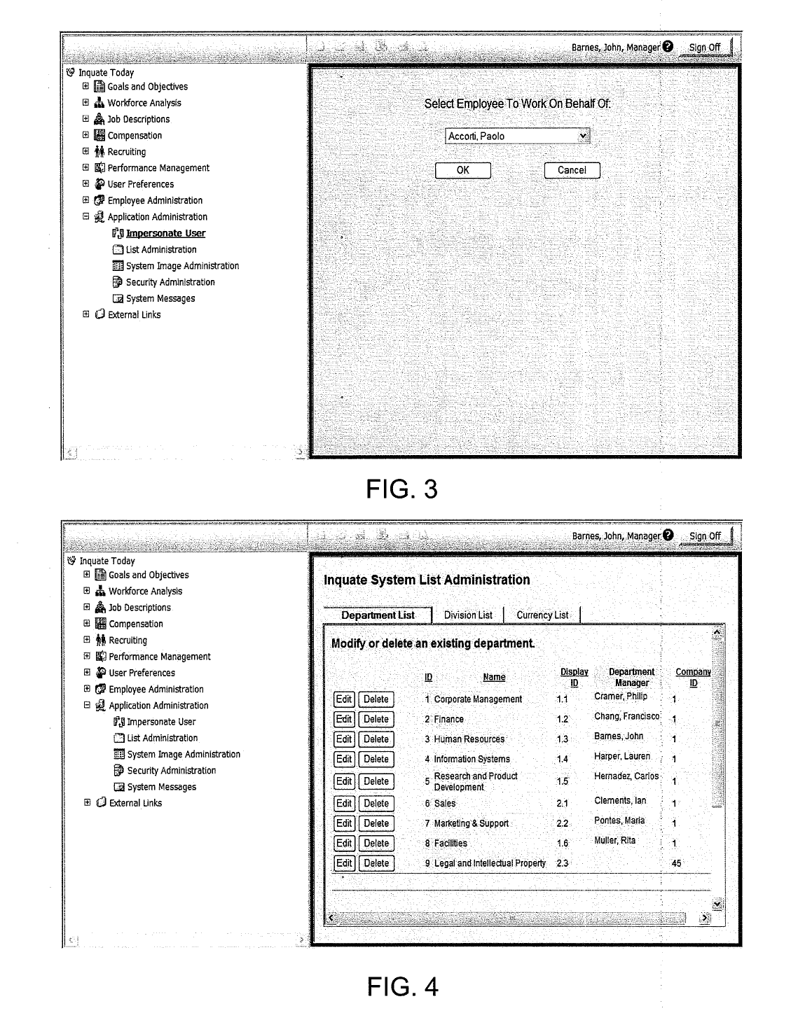

In some respect, modules M1 through M7, as shown in FIG. 2, may each integrate with one or more of the remaining user module. Data from, for example, employee data module EM or other sources such as the internal and external data sources may be collected, along with a user preference module (UPM) and forwarded to the application administration (AM).

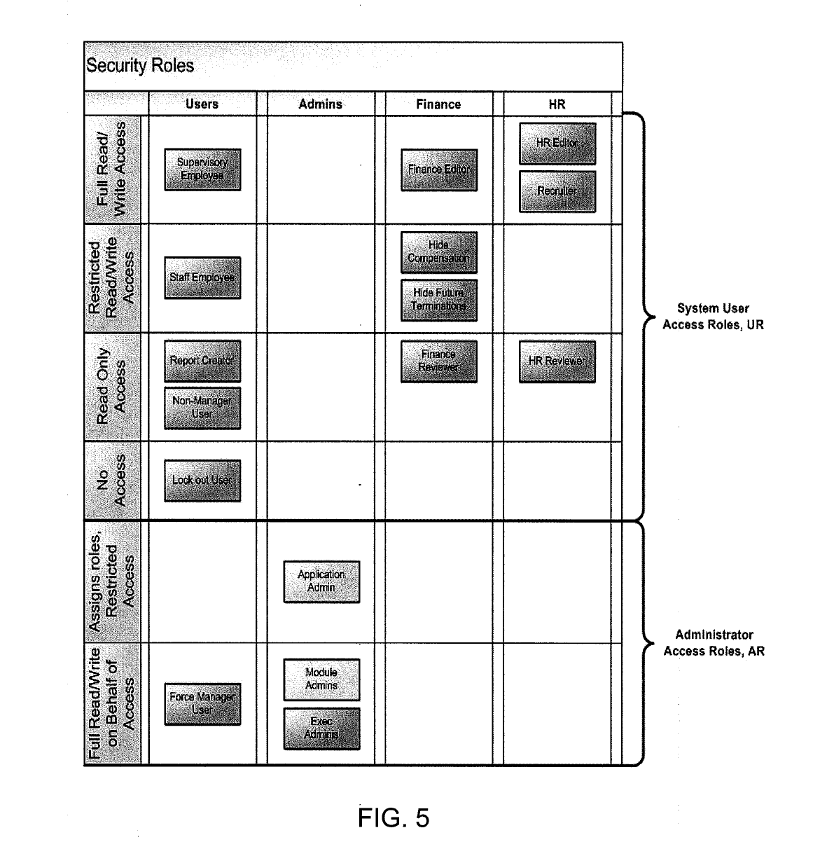

Referring to FIG. 5, the roles, divided into the two main categories and labeled System user Roles (UR) and administrator Access Roles (AR) are shown. In some embodiments, the UR may define a default employee role where all employees have access unless otherwise noted. This role may also be assigned to non-employee named users for access to the system. Each of these roles is described in more details below.

System User Roles

In one respect, the default employee role may provide rights limited to the following some or all of the modules. For example, the default employee role may allow access to the Goals & Objectives module M1, where non-supervisory employees may edit objectives. In addition to or alternatively, the default employee role may allow for editing of objective progress, marking an objective as complete, determining of stakeholder(s), e.g., individuals who may assist with the accomplishment of the objective, editing the progress as a stakeholder, viewing all developed and ad-hoc reports.

For supervisory employees, the default employee role may provide for at least the same functions of non-supervisory employees. Additionally, supervisory employees may enter and edit objections not for themselves, but also for subordinate employees. Further, the supervisory employees may choose stakeholders on behalf of subordinate employees and may delete objectives of subordinate employees. The default employee role may also provide access to workforce analysis module M2. In some embodiments, non-supervisory employees may not have access. Supervisory employees may have access to information, including, without limitation, any employees name, title, salary, and date of hire. Additionally or alternatively, supervisory employees may be able to recommend new positions and/or exclude employees from a new budget.

In some embodiments, the default employee role may provide access to job descriptions module M3. Non-supervisory employees may have access to, for example, position description which may be provided in report formats.

Supervisory employees may also have access to job descriptions module M3. In some embodiments, supervisory employees may be able to enter a new description of a position or edit an existing description. Alternatively, supervisory employees may copy the contents of an existing description of an existing job position to a newly titled position.

For performance management module M6, the default employee role may allow access by both non-supervisory and supervisory employees. In particular, non-supervisory employees may be able to complete a self-appraisal. Non-supervisory employees may also be able to recommend changes to their respective position description through, for example Performance Management module M6. Additionally, the non-supervisory employees may recommend a position's job tasks, which may subsequently provided to a direct supervisor for review and/or approval.

Similarly, supervisory employees may be given the same access as the non-supervisory employees in M6. Additionally, the supervisory employees may be able to appraise direct and non-direct subordinate employees and may be able to recommend changes to a position description of subordinate employees. The recommended changes may be stored in a pending file in Job Descriptions module and may be reviewed by an administrator of M3.

For succession planning and training module M7, supervisory employees may develop a training agenda for non-supervisory employees. Non-supervisory employee may review his or her career path and training agenda but may not have editing rights.

In some embodiments, the default employee role may provide access to only supervisory employees. For example, workforce analysis module M2 (described above), compensation module M4, and recruiting module M5 may only be available for access by supervisory employees. In some respect, for compensation module M4, the supervisory employees may be able to recommend salary increases for all subordinate employees. In addition to or alternatively, the supervisory employees may be able to recommend bonus amounts/percentages for all subordinate employees.

For recruiting module M5, the supervisory employees may be able to request consideration for additional positions needed in the workplace. In addition to or alternatively, the supervisory employees may be able to track the hiring activity provided the requests for the new additional positions are approved and active.

Administrator Access Roles

In some respect, an application administrator may have specific rights, mostly relating to role assignments for other users and module administrators. If the application administrator requires increased rights, they may also add themselves to the Administrator roles for any module.

In some embodiments, an application administrator may impersonate a user of the application. This may allow the application administrator to enter data on behalf of the user. The application administrator may not inherit any other roles assigned to the impersonated user. The system records all data entered on behalf of a user and marks it as such.

Additionally, the application administrator may assign roles for the users of the applications. Once an employee is assigned the role of, for example, from non-supervisory employee to module administrator, the application administrator may update the status of the promoted employee and assign the old position to another employee. The application administrator may also change an employee from a supervisory role to a non-supervisory role or any other role as defined. The application administrator may also add, edit, or remove announcements displayed to users in the system. In some embodiments, the announcements may inform system users regarding the status of each of the modules. For example, the application or module administrator may announce that all employees need to begin the performance appraisal process using the announcement process in performance management module M6.

Personnel Responsibilities

Referring again to FIG. 5, for modules M1 through M7, various personnel may be responsible for different aspects. The following is a description of the responsibilities for each of these personnel.

1. Module Administrators

As noted above, each module may have one or more module administrators that have different administrative tasks. For example, goals and objectives module administrator(s) (administrator(s) for module M1), may have full access and all associated rights assigned to a limited number of people by, for example, a human resource department or one with responsibilities for corporate strategies.

In one respect, the MI module administrator(s) may coordinate and enter the organization's initial goals in preparation for the ensuing year. M1 module administrator(s) may also assists other users in the development of objectives in support of the corporate goals. Accordingly, the M1 module administrator(s) may have impersonation rights and may enter, edit, and delete objectives on behalf of the user.

A workforce analysis module administrator or administrators for module M2 may be accorded full access and associated rights to module M2, and in particular, access to information about future personnel reductions. In some embodiments, the M2 administrator may be assigned to a very limited number of users, preferably no more than one, who work in the role of a corporate strategist or a human resources professional. For example, the M2 administrator may be limited to the managers and those in the HR and accounting departments.

Job descriptions module administrators may have full access and rights for serving as a module consultant. The M3 administrator may assist managers or other supervisory employees produce and edit position description by, for example, impersonating the manager or other supervisory employees. Additionally, the M3 administrator may provide final approval and locking the descriptions as they become available either as a result of the production of a new description or edit of an existing description through module M3 or module M6.

In some respect, the M3 administrator role may be assigned to a limited number of people. A typical user granted these rights might be assigned to the human resources department. Accordingly, he/she has full rights and access to the module.

For the compensation module M4, the module administrators may have full rights that allow for, amongst other things, access to salary and bonus setup screens. This may allow for adjustments of salary and bonus recommendations for any use. Additionally, M3 administrator may assign security roles for different users of the system, to prevent access to employee and department data.

Additionally, the M5 administrator determines the disposition of all incoming requisitions for new positions and sets the status of all requisitions. The M5 administrator may serve as a module consultant assisting hiring managers or other supervisory employees with the development of requisitions and position descriptions as necessary.

For the performance management model M6, an administrator may be assigned to a limited number of users, preferably no more than one, who may work in the role of a human resources professional or an individual who has overall responsibility for the completion of performance appraisals. The M6 administrator may have full access and rights to an individual who serves in the role of module consultant. As a consultant supporting the module, the M6 administrator may provide guidance to system users regarding the content of each of the M6 module or other modules. For example, the module administrator/consultant may assist an employee with how to write a justification for a self-appraised rating of exceeding expectations. Additionally, the M6 administrator may have impersonation rights for assists any users with the development of subordinate or self appraisals. The M6 administrator may be responsible for ensuring appraisals are completed on a timely basis.

The administrator of M7 may be assigned to a limited number of users who may work in the role of a human resources professional or an individual who has overall responsibility for the training of employees. In one respect, M7 administrator may rank the employees in succession for each position and assist in the development of a training plan for each employee.

2. Executive Assistant

An executive assistant role may allow assistants of executive and/or administrator personnel to perform limited work on his or her behalf. The executive assistant may access the executive or administrator's direct report performance appraisals and complete the appraisal(s) at the direction of the executive and/or administrator. This role does not inherit any other roles assigned to their supervisor. For example, the executive assistant role may not serve in a supervisory role regarding his or her own performance appraisal.

3. Finance Editor

A finance editor role may allow a finance specialist or accountant the ability to edit the recruiting budget data in recruiting module M5. The financial editor may typically have access to compensation information as well as information about future personnel reductions. Additionally, the finance specialist or accountant may edit bonus accruals and bonus and salary budgets compensation module M4.

4. Finance Reviewer

A finance reviewer may be a finance specialist or accountant that has read-only access to all reports containing confidential data including the information contained in modules M4 and M5.

5. Human Resource Editor

A human resource editor may have full access to recruiting module M5. The human resource editor may enter new positions, add a recruiting budget, add progress and notes, enter expenses associated with recruiting, and designate a position's final status (filled, canceled, pending, etc.). In some respects, the human resource editor may have limited rights as compared to module administrators. For example, while a module administrator for the goals and objectives module M1 can edit all goals and objectives, the human resource editor cannot perform these same functions.

6. A Human Resource Reviewer

A human resource (HR) reviewer may e have read-only access to information within the recruiting module M5 The HR reviewer may utilize input dialogs for looking up and reviewing information within module M5, although the add/edit/delete functionality may be disabled. In some respects, the HR reviewer has limited access to module M5 and is limited to viewing the data through the reporting function. Additionally, the HR reviewer may export recruiting data for use by external reporting/data mining system.

7. Recruiter

In some embodiment, a recruiter may be extended to an individual outside of the company. Accordingly, the external recruiter may be limited to only those positions assigned to him/her following agreement and will have no other access to any other part of the application. In these arrangements, the outside recruiter may review and edit information relating to recruiting activity. For example, the recruiter may be privy to a number of candidates considered, number of candidates interviewed via telephone, number of candidates interviewed on-site, number of offers extended and rejected, and the date the final candidate accepted the offer. In some respects, if the outside recruiter is assigned a new position or if a position status is changed, the recruiter may be updated. This may accomplished through the security administration section of the Application Administration module AM.

8. Report Creator

A report creator is a user that may have access to the development of ad-hoc reports. Following development of the reports, the report creator may “lock” the query path for saving the report for later use. In some embodiments, locked reports may be stored on a server storing the modules.

9. Force Manager User

Force manager user is a person that has supervisor status even if the user does not have any assigned subordinates. For example, this role may be assigned in circumstances where an employee is serving in a temporary role as a supervisor while the regular supervisor is on leave. This role is used in all modules and may override the defined management hierarchical.

10. Non-Manager User

Non-manager may be a user that has assigned subordinates but does not have access similar to those with supervisory positions. For example, this role may be used in temporary situations where an upper level manager takes the role of a subordinate supervisor in an effort to render decisions regarding the subordinate supervisor's employees. This role is used in all modules and may override the defined management hierarchical.

Exclusionary Roles

For each of the above roles of various personnel, there may some overriding exclusionary roles. In particular, three exclusionary roles are provided including: 1) restrict all access; 2) report no compensation; and 3) report no terminations. Generally, an exclusionary role may take priority over any assigned roles outlined above. Each of these exclusionary roles is described in more details below.

Restrict All Access—Exclusionary Role

The restrict all access role may be used prevent assigned users from using the system by logging all attempts. For example, when an employee is terminated, it may be necessary to immediately lock the employee out of the system, thus ensuring he or she has no opportunity to harm the system.

Report No Compensation—Exclusionary Role

In some embodiments, some administrator roles may be conflicted. For example, a recruiting administrator (M5 administrator), should not see any salary information in any dialogs or reports that normally would display salary information. Therefore, the report no compensation role may exclude compensation information that is available to a user due to another role assignment. In some embodiments, the user assigned this exclusionary role may not have any knowledge of this exclusionary assignment.

Report No Terminations—Exclusionary Role

Similarly, a M2 administrator should not see any information in any dialogs or reports that would indicate future personnel reductions. As such, the report no termination role may cause the system to exclude future reductions in force information that is available to a user due to another role assignment. In some embodiments, the user assigned this exclusionary role may not have any knowledge of this exclusionary assignment.

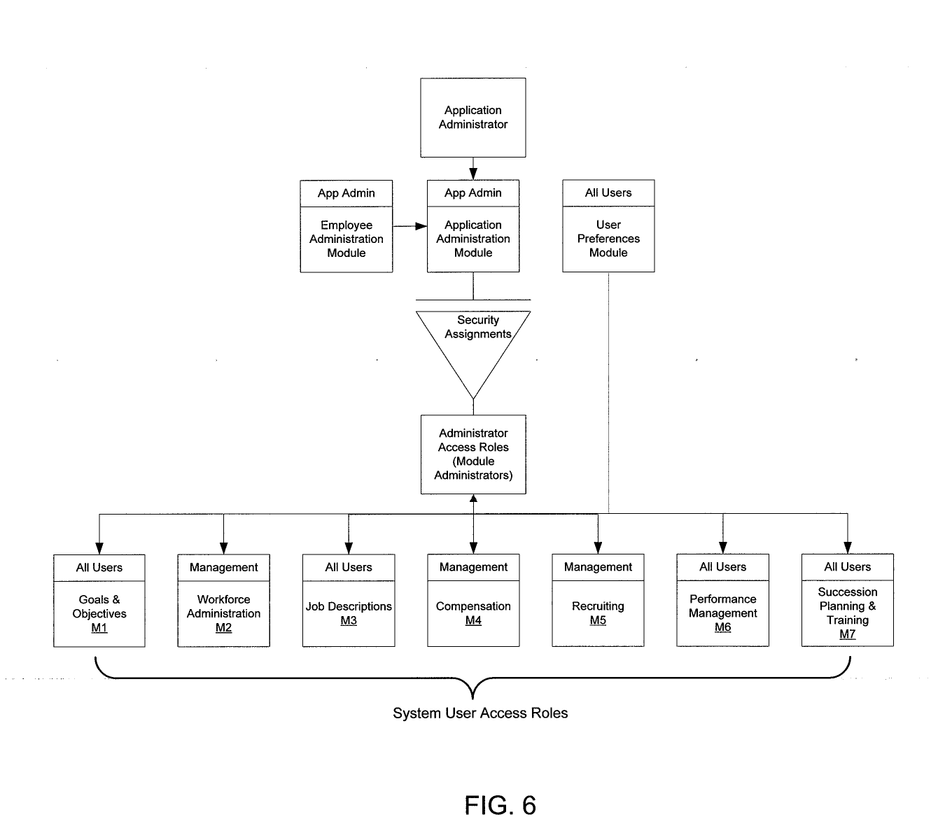

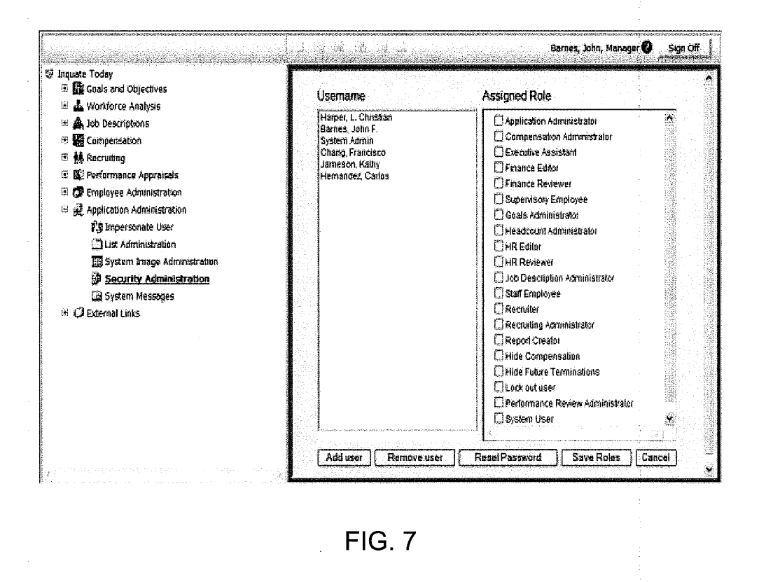

Referring to FIG. 6, a chart illustrating security roles for different personnel are shown according to embodiments of the present disclosure. The present disclosure may determine what roles have been assigned to the user, e.g., system user role or administrator role, and presents what data may be accessed by each personnel. The roles are established by the application administrator, shown in FIG. 7. For example, an application administrator may select a user in the “Username” window and the appropriate checked and unchecked boxes indicating roles of the selected user is shown.

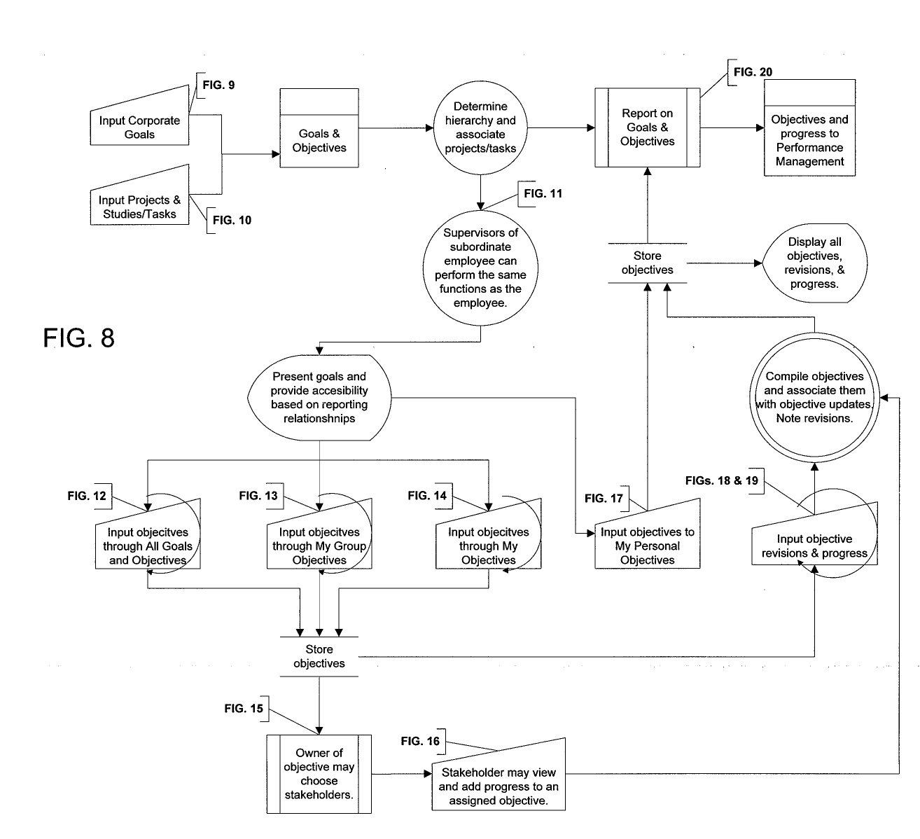

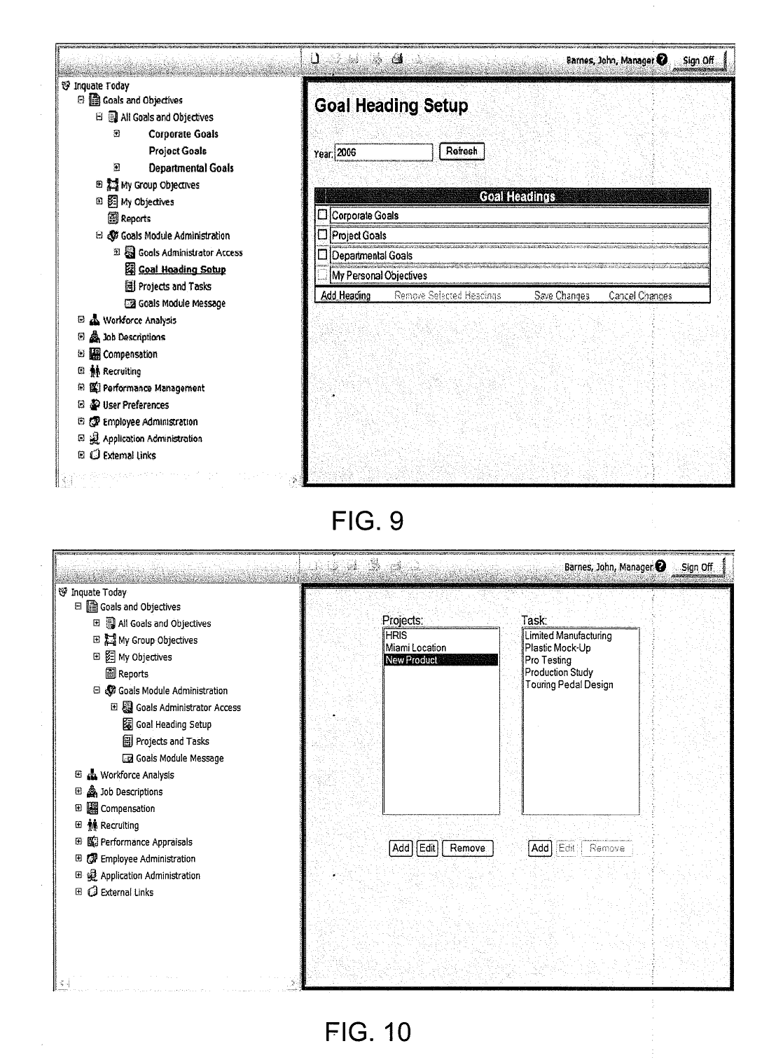

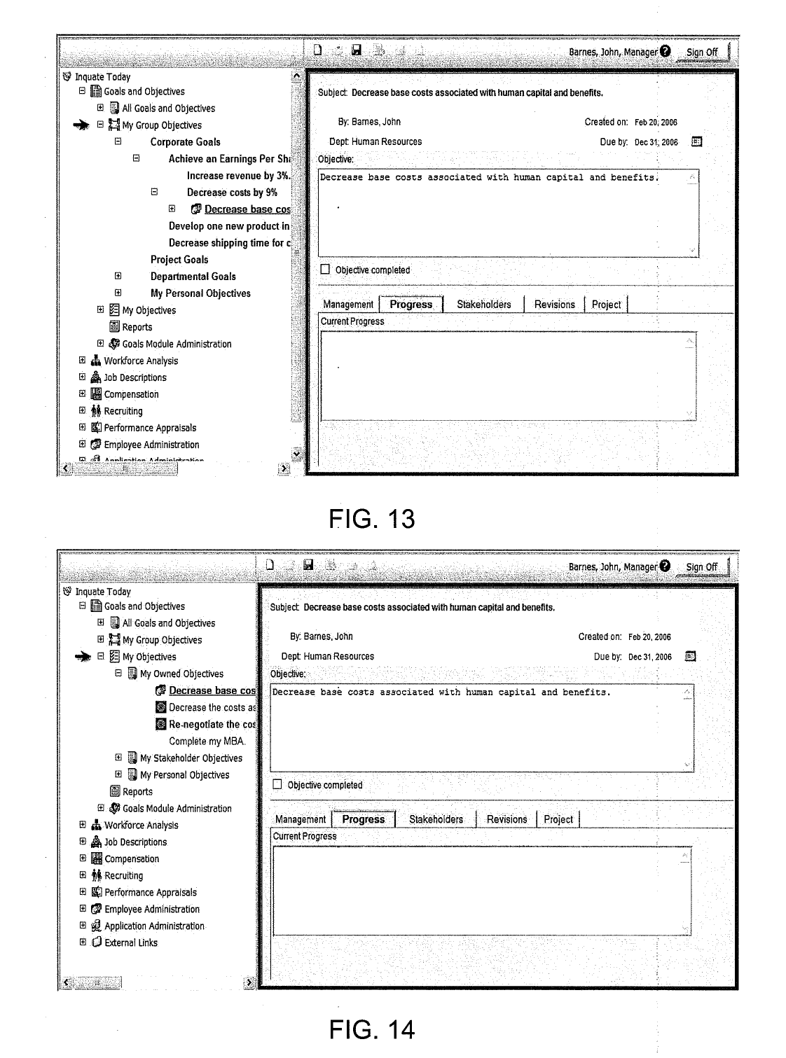

Referring to FIG. 8, a flowchart of the functions of the goals and objectives module M1 is shown. FIGS. 9 through 19, corresponding to the steps shown in FIG. 8 illustrate graphical user interfaces (GUIs) presented to a user (e.g., non-supervisory or supervisory) for recording inputs.

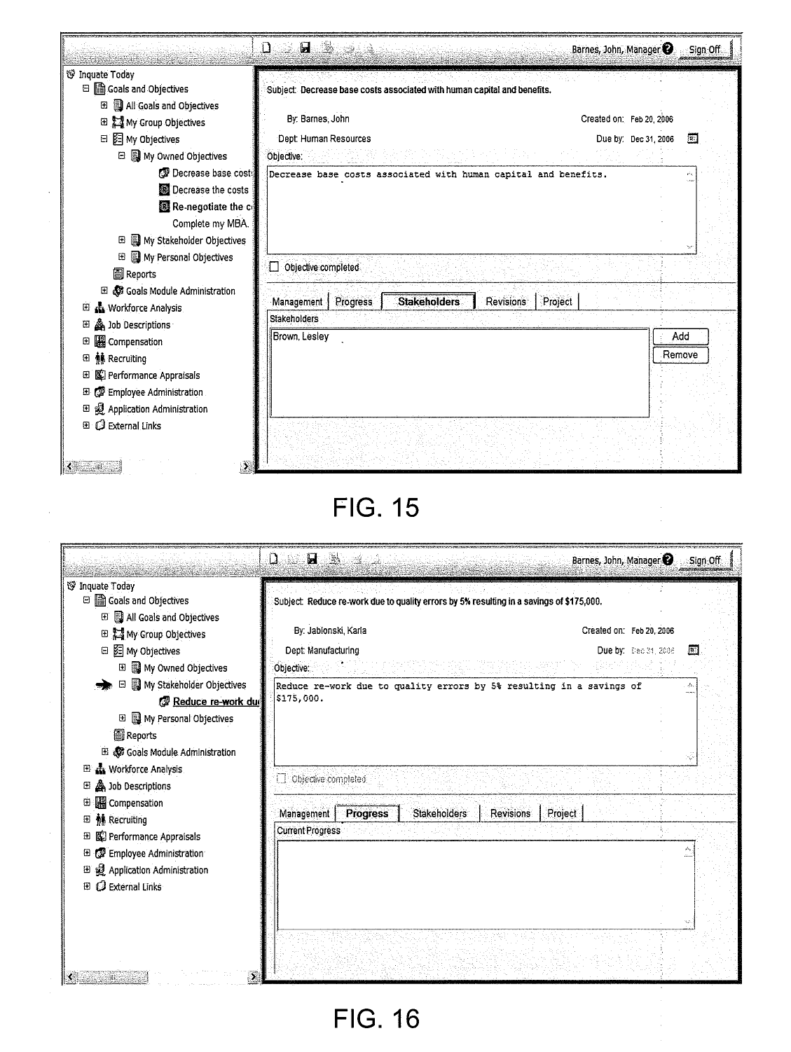

In one respect, the goals and objectives may be listed in hierarchical fashion in order to allow a user to quickly ascertain where an objective should be placed, as shown in FIG. 9 (illustrating the where corporate goals, projects goals, department goals and personnel goals are ranked in the hierarchy). FIG. 9 may also used to initially establish goal headings. In some embodiment, a supervisor's objectives may be presented in bold font for easy discernment. Accesses to a supervisor's objectives may be limited to adding a supportive objective, e.g., provides details to the intent and purpose of a lead objective. Once the supportive objective is entered by a user, the objective is presented in blue font to the owner. The user may choose to include individuals who will assist with the accomplishment of the objective as shown in FIG. 15. These are stakeholders. Stakeholders are sent a message automatically via email inviting them to participate in the objective.

A module administrator (e.g., M1 administrator) may enter the company's goals in the system by selecting the box to the “Corporate Goals” shown in FIG. 9. Also provided is a project and study/task tracking, as shown in FIG. 10. Projects and tasks may be assigned to a goal heading, goal, or lead objective. Thus, a goal heading in FIG. 9 may be assigned to a project or task. In some embodiments, projects and tasks may be inputted as dictated by the module administrator. Each objective may be associated with the appropriate project or project and task.

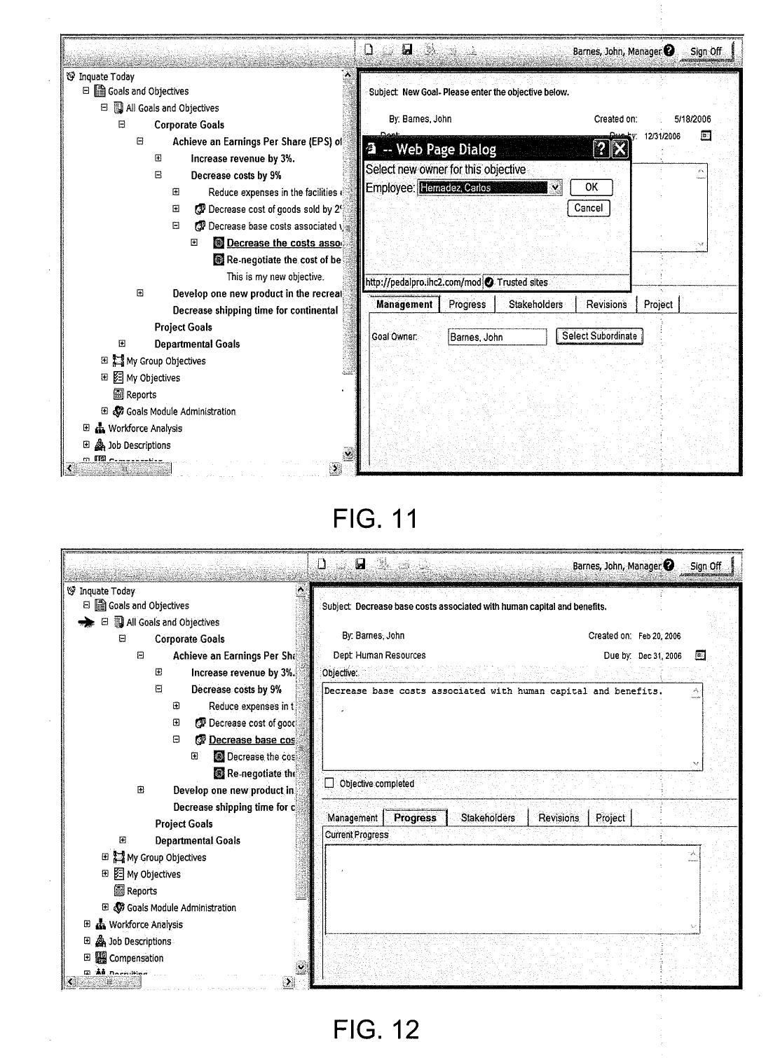

While a user may input objectives in support of the goals, a supervisor may act on behalf of the subordinate user. For example, referring to FIG. 11, a GUI may be provided to the supervisor allowing the supervisor to select an owner of the objective.

Following the development of existing goals and lead objectives (as appropriate), the GUIs presented in FIGS. 12, 13, 14, and 15 may allow a user to input his/her own objectives using the All Goals and Objectives view, the My Group Objectives view, or the My Objectives view, respectively. The My Objectives view includes two sections: My Owned Objectives and My stakeholder Objectives (shown in FIG. 15). As a stakeholder, the user may view and add progress to the objective but may not add additional stakeholders, change or delete the objective.

A user may also input objectives of a personal nature, using the GUI shown in FIG. 16. These objectives may only be viewed by the user and his or her superiors.

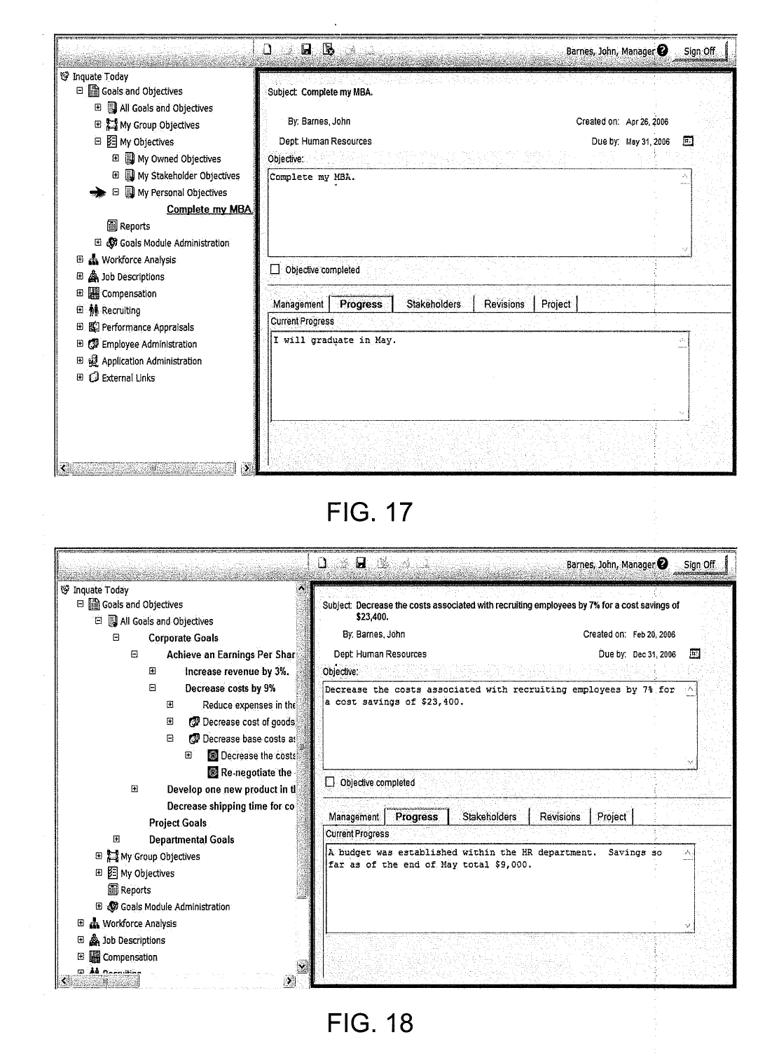

Progress reflecting each objective may be inputted by the objective's owner or the stakeholder using the GUI shown in FIG. 17. Once progress is added to an objective the progress information is shared with the performance management module M6.

In some embodiments, each of the objectives may be changed or updated by the user. To do so, the user overtypes the existing objective replacing it with a revised objective. The date the objective is due may also be changed. The revision is then recorded and maintained via FIG. 10. Revisions may be viewed by any user and there may be no limit to the number of revisions that can be made.

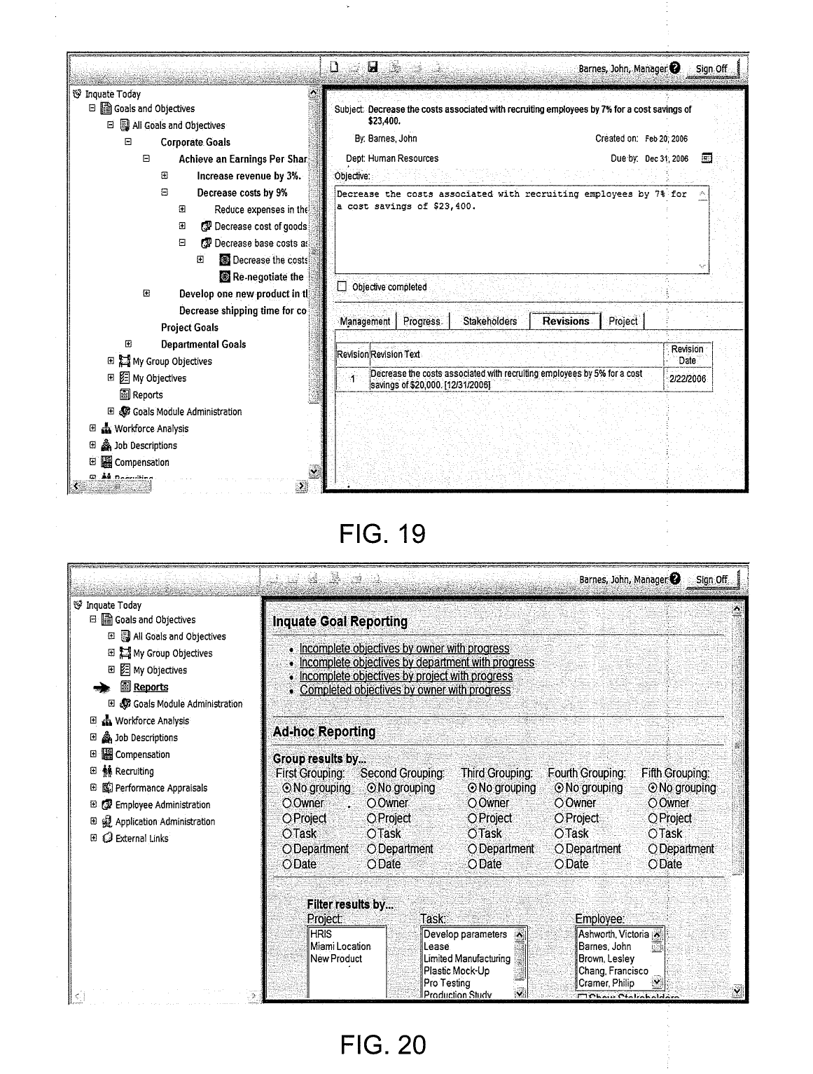

The present disclosure may also provide the ability for the appropriate user to request ad-hoc reports and pre-formed reports that are readily available via FIG. 19. The report may be provided for example, via the GUI shown in FIG. 20.

One of ordinary skill in the art would recognize that some or all of the GUIs of module M1 may be used at one time. In addition to or alternatively, the GUIs may be presented in any order and may be saved for further edits in the future.

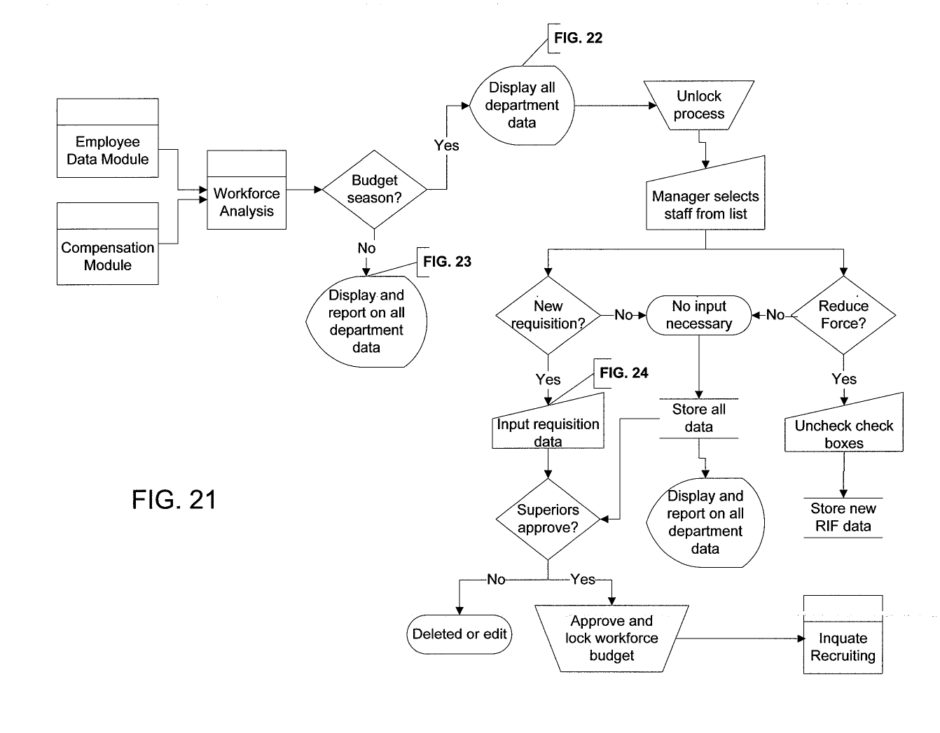

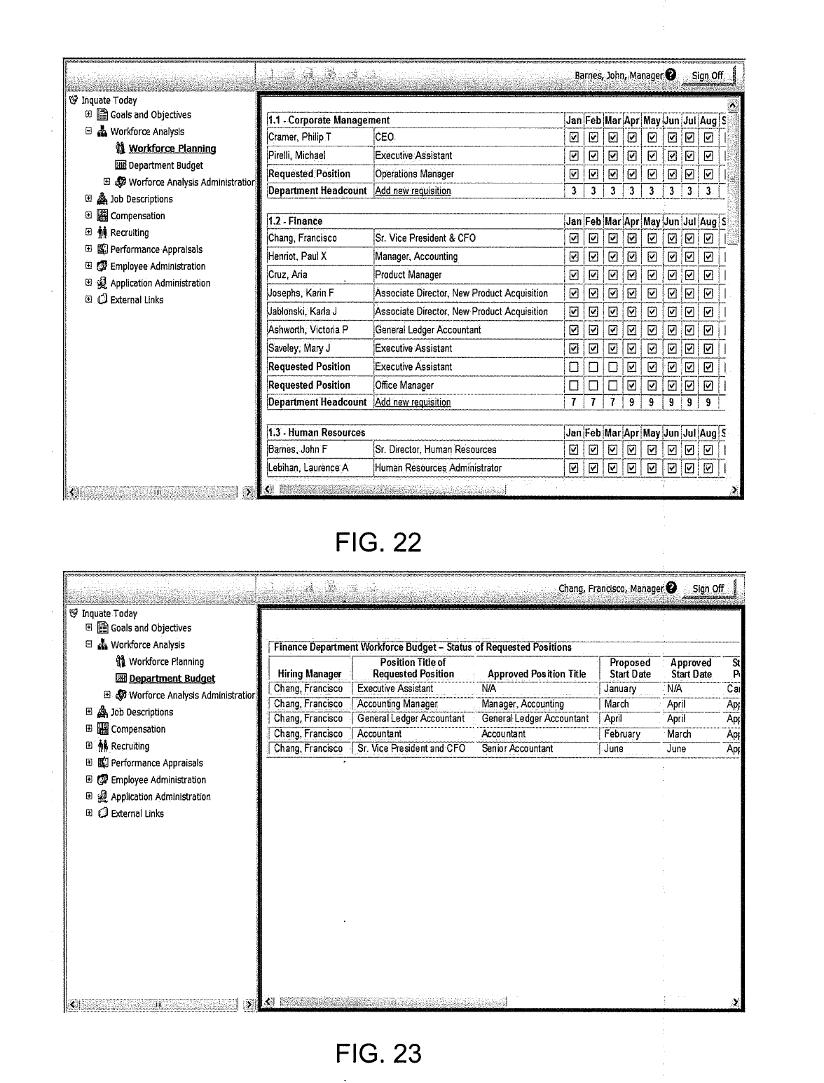

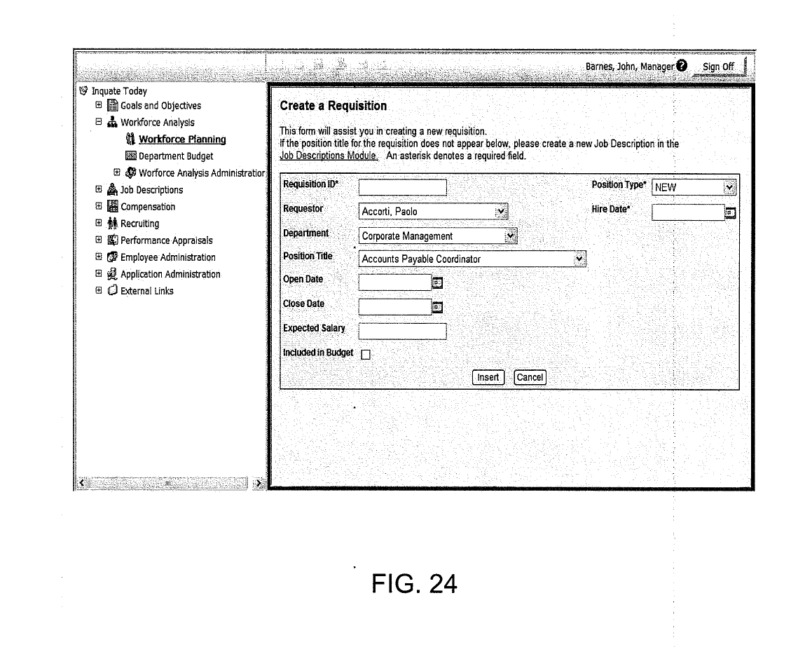

Turning to FIG. 21, a flowchart of the functions of the workforce analysis module M2 is shown. In some embodiments, supervisory users may view data containing information reflecting current department staff via the GUI shown in FIG. 22. During periods of budget planning, M2 administrator may unlock the module, and thus allowing supervisors to provide recommendations pursuant to the forthcoming year's headcount, via GUI shown in FIG. 23. With limited access to their specific department(s), supervisors may recommend increasing or decreasing their staff. When requesting consideration for a new position using the GUI shown in FIG. 24, the requisition relies on data from compensation module M4 in order to appropriately price the position. Once the process is completed, M2 administrator may lock the system and produces the appropriate ad-hoc reports in order to complete the budget.

One of ordinary skill in the art would recognize that some or all of the GUIs of module M2 may be used at one time. In addition to or alternatively, the GUIs may be presented in any order and may be saved for further edits in the future.

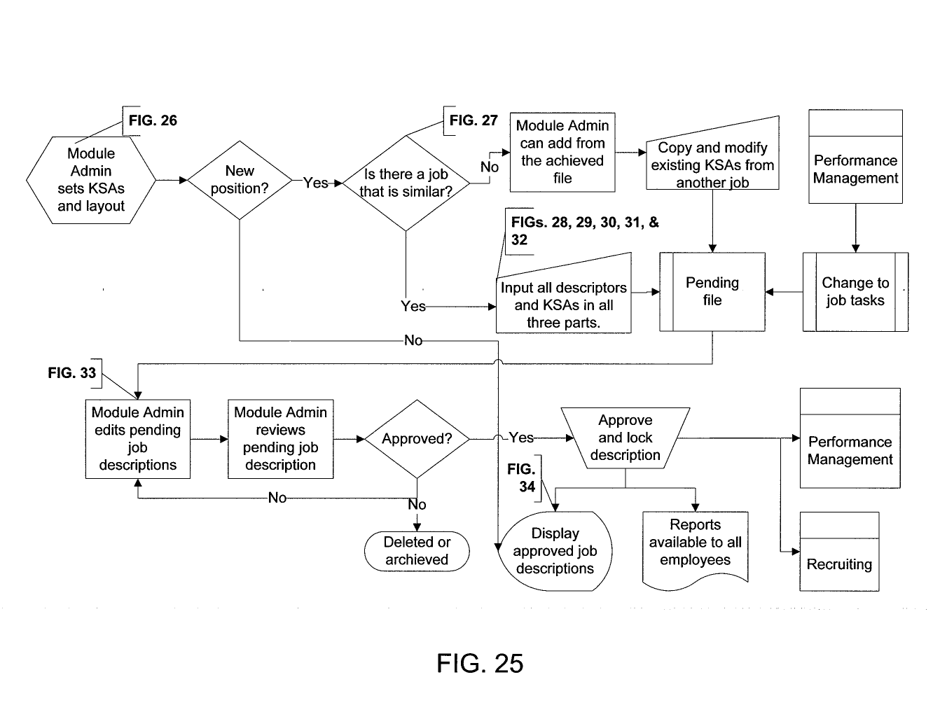

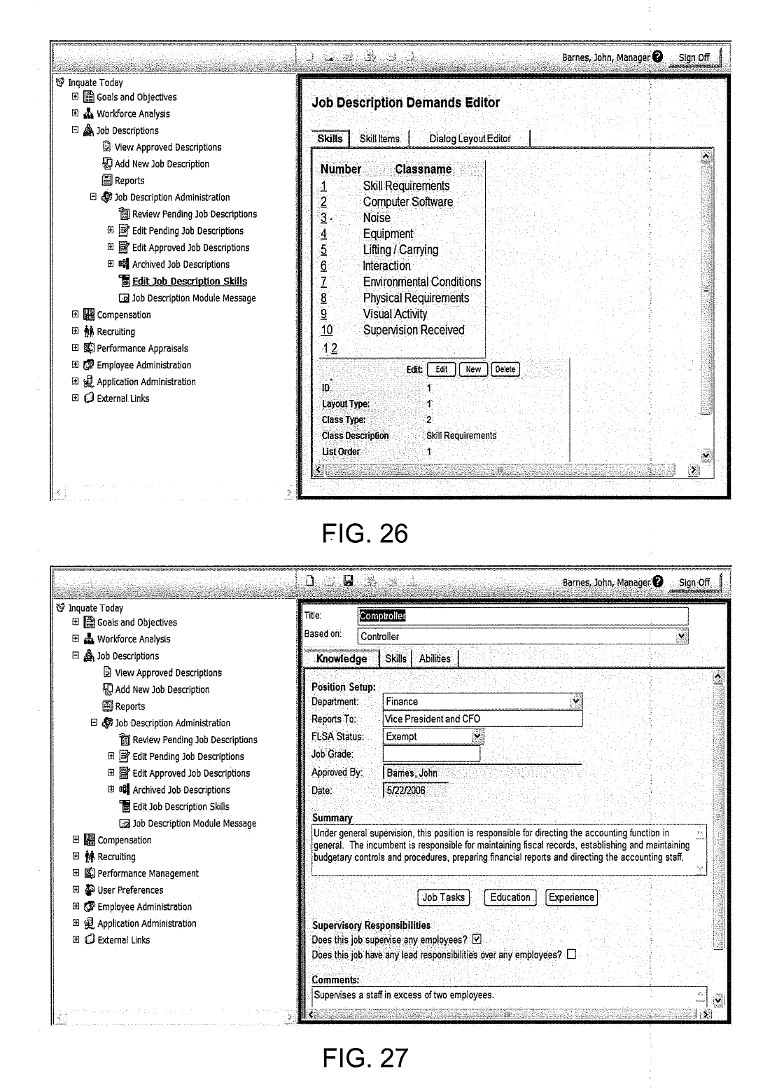

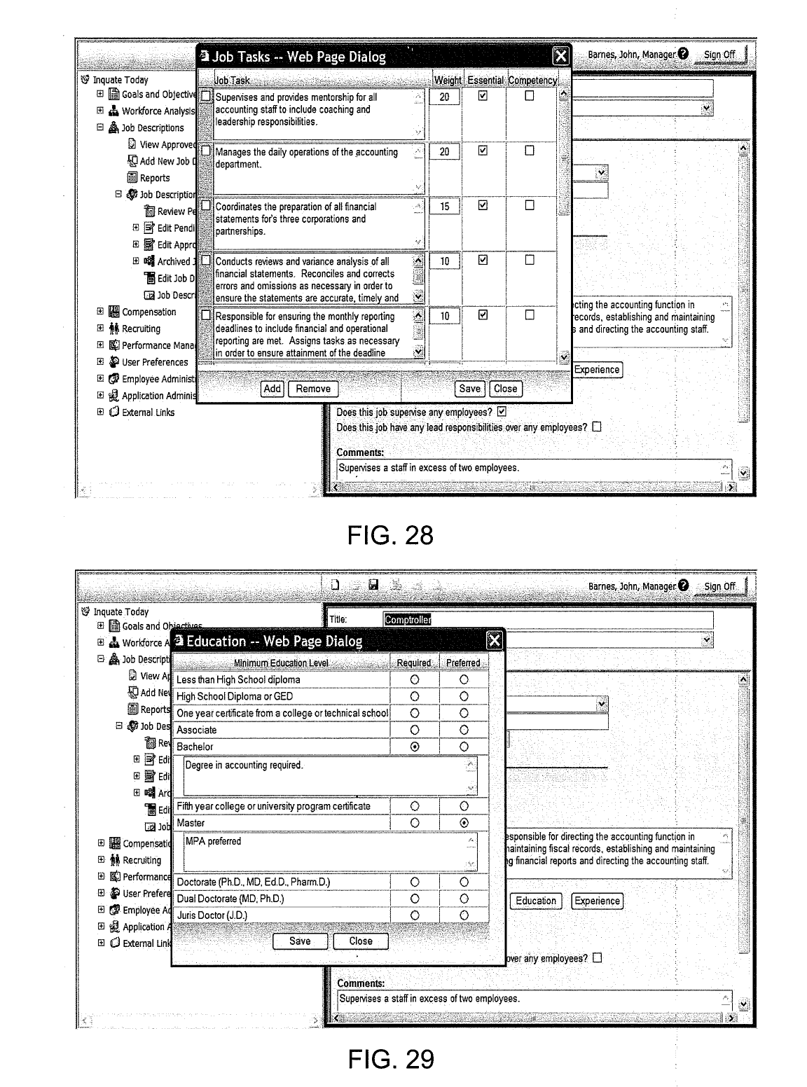

Referring to FIG. 25, a flowchart of the functions of the job description module M3 is shown. In some embodiments, a supervisory user and/or a M3 administrator may add, update, and copy position descriptions. Starting with the GUI shown in FIG. 26, the M3 administrator may establish skill titles, specific skill items, and dialog layout editor of the pages using the tabs provided if desired. Depending on whether the new description is based on another description, a system user who may be an individual with management responsibilities and may have access to input or edit a summary of various position responsibilities using the GUI shown in FIG. 27. The user may continue by entering or editing job tasks in the GUI shown in FIG. 28. In some embodiments, each job task may be provided a function weight representing the percent of time spent on task. Additionally, competencies, further detailing the responsibilities, are input in the GUI shown in FIG. 28.

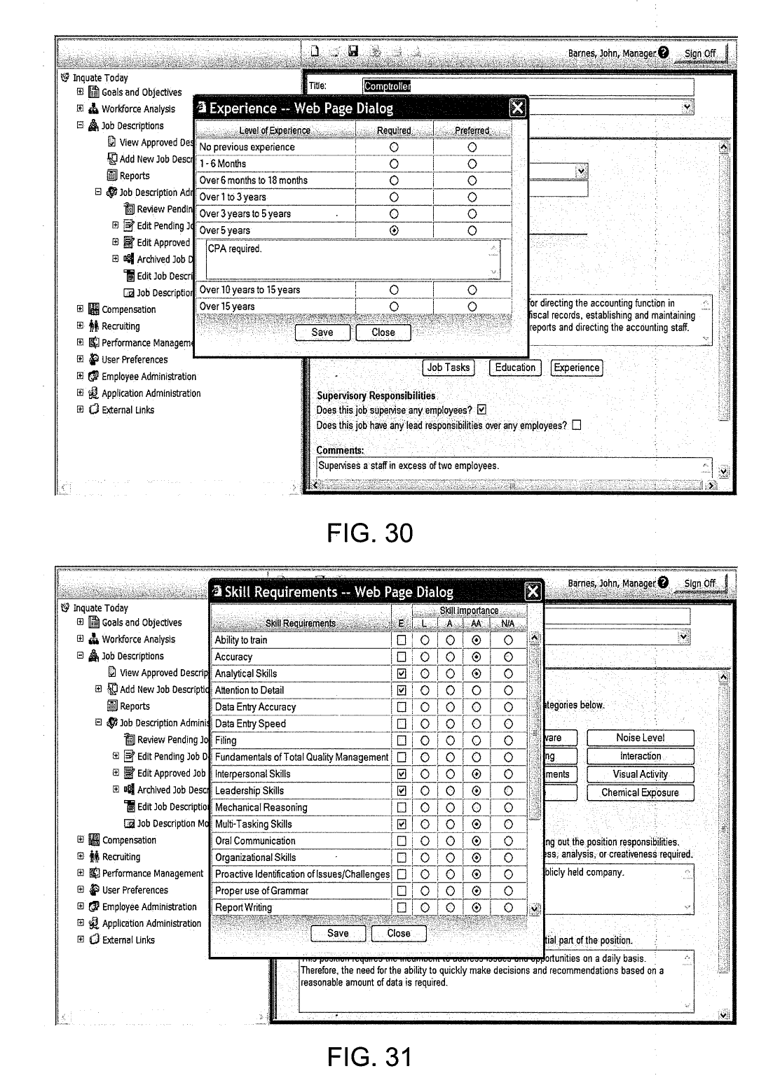

Using the GUI shown in FIG. 29, the user may define or edit the preferred and required level of education. The user may choose to further define the educational requirements by delineating what degree is necessary. Using the GUI shown in FIG. 30, the user may define or edit the experience required. As is the case with educational requirements, the user may add detail with respect to the amount of experience is necessary.

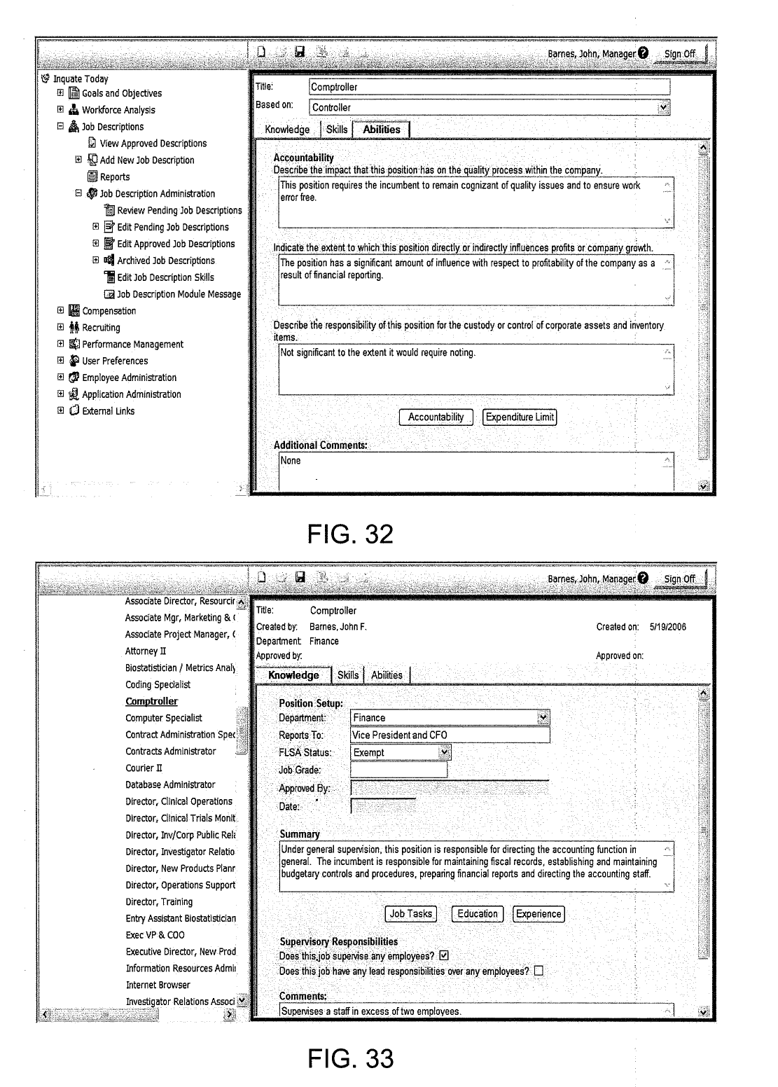

Additionally, a user may define in detail the skill requirements using the GUI shown in FIG. 31. The GUI may allow the user to note whether the requirement is essential in accordance with the Americans with Disabilities Act (ADA). In some embodiments, there may are a number of skills available for the user from which to choose, such as, but not limited to skill requirements (e.g., ability to train, attention to detail, leadership skills), computer software used, expected noise level, equipment used, lifting/carrying requirements, interaction with others, expected environmental conditions, and others.) A user may further detail the requirements of the position by completing the position accountabilities section using the GUI shown in FIG. 32.

Once a position description has been completed by a management user, the description may be considered a draft description and is sent to a pending file for approval consideration, using the GUI shown in FIG. 33. Providing the position is approved, the description of the position may s locked with the date and the name of the M3 administrator as the individual who approves it.

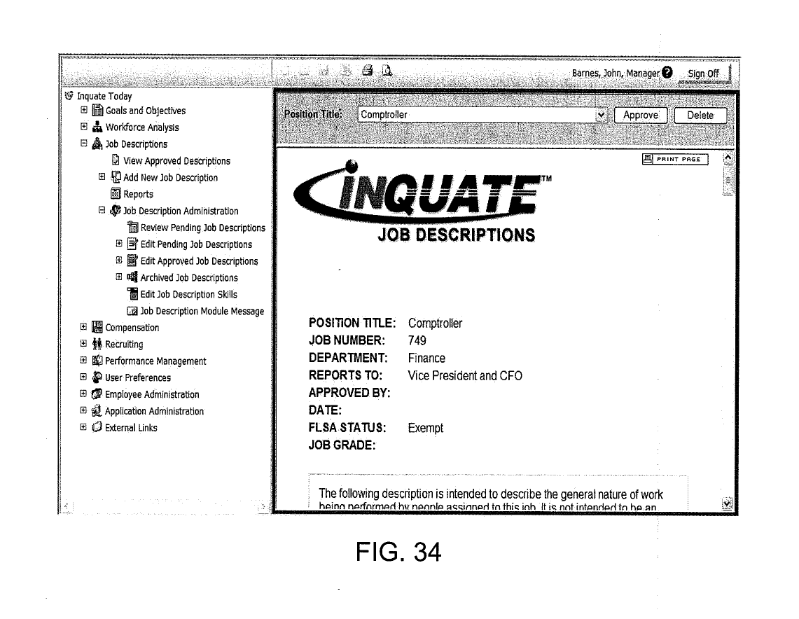

In some embodiments, the M3 administrator may approve his/her own position descriptions following input or edit, using the GUI shown in FIG. 34. Any of the above job description information may be shared with performance management M3.

One of ordinary skill in the art would recognize that some or all of the GUIs of module M3 may be used to enter a job description. In addition to or alternatively, the GUIs may be presented in any order and may be saved for further edits in the future.

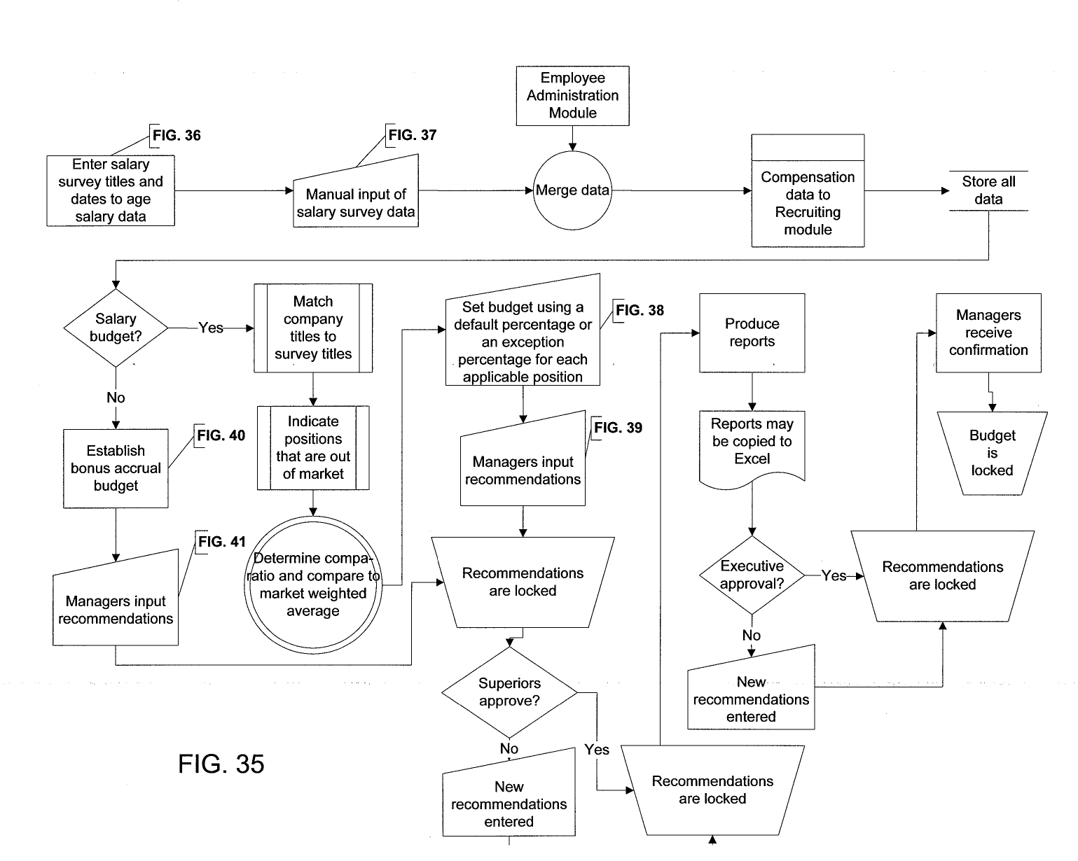

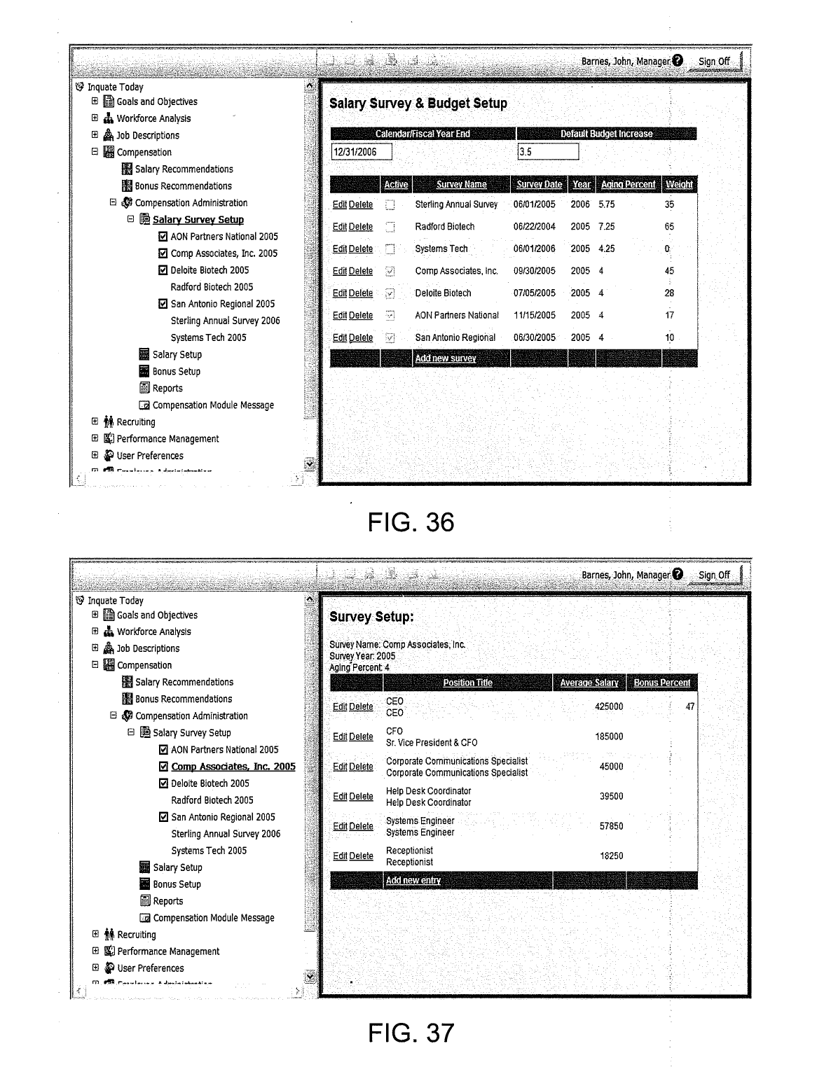

Turning to FIG. 35, a flowchart of the functions of the compensation module M4 is shown. A compensation module administrator (M4 administrator) may the entry of salary survey data into the module using the GUI shown in FIG. 36. The survey data may include, without limitation, the date the salary survey was completed as well as the title of the survey. M4 administrator may also defines the wage inflation fact and the default salary budget for the company overall.

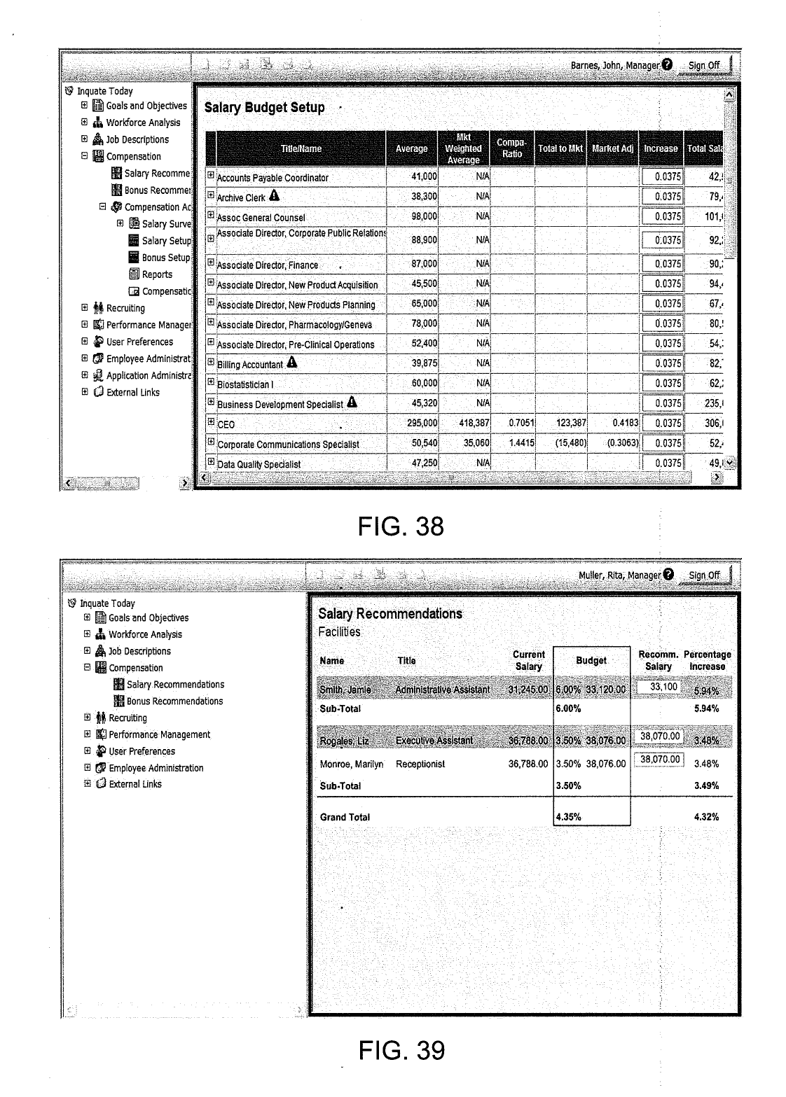

Additionally, external salary data reflective of an internal position on a one to one position basis may be entered via the GUI shown in FIG. 37. M4 administrator may determine whether he/she may want to weight each salary survey reflective of whether the position draws from a local or national labor market. M4 administrator may also provide a summary of the overall status of the positions relevant to the external market based on the company's salary structure via display of the compa-ratio using the GUI shown in FIG. 38.

Using the GUI shown in FIG. 38, the M4 administrator may choose to allow the default increase budget to apply to each position or he/she may choose to override the default budget and approve a higher budget if the applicable position is significantly below the external labor market according to salary survey data. The process may allow outliers within the company's compensation structure pursuant to each position to be excluded from the comparison process. Positions that are above or below the over/under analysis boundary may be considered for larger or smaller increases by the M4 administrator. Using the GUI shown in FIG. 39, a supervisor may recommend salary increases for each employee. Recommendations outside of the established budget may require a justification by the supervisor. The supervisor may also recommend actions for each employee including promotional increases using the GUI of FIG. 39. The manager may be prompted to support recommendations that are above or below the budgeted salary increase.

Once the salary budget is completed corporately, the process may be locked by the M4 administrator and reports may be prepared by the module. Following approval by an executive management, the compensation data may be subsequently shared with recruiting module M5 and workforce analysis module M2.

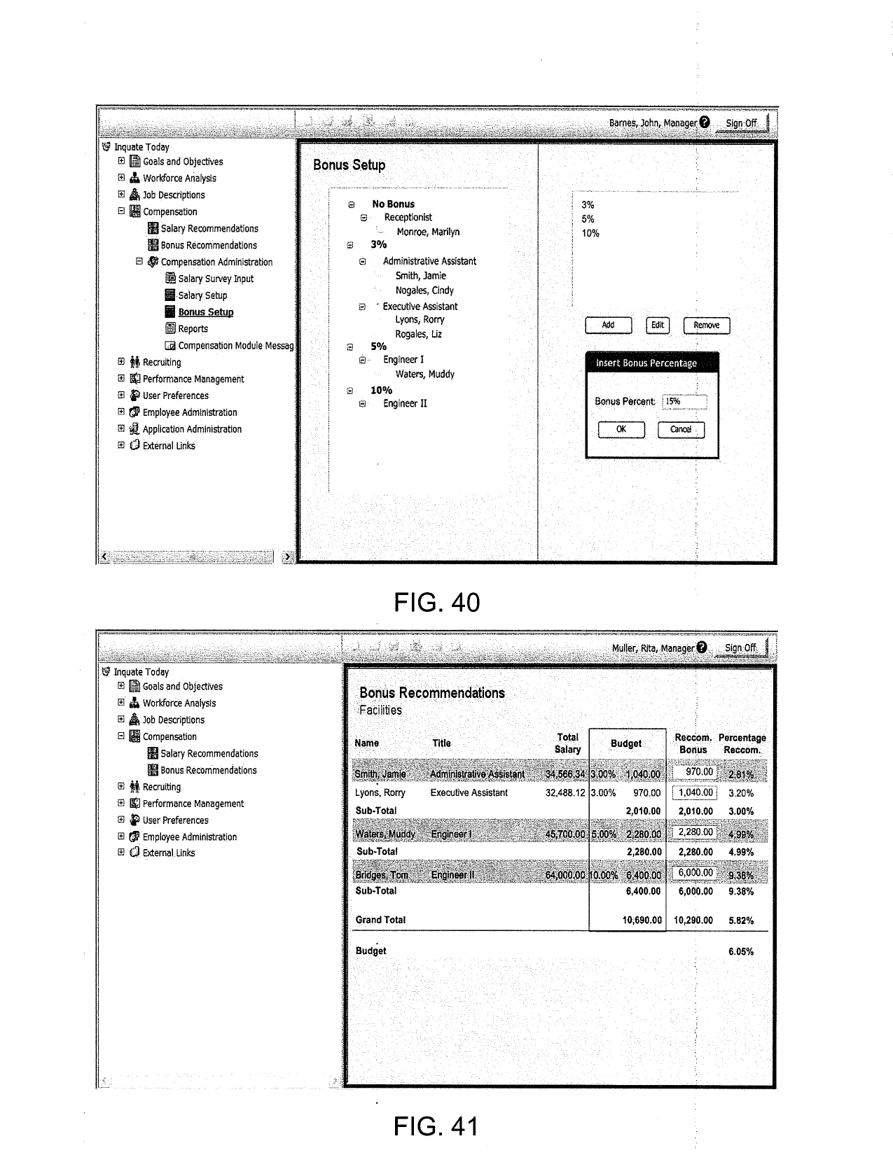

Using a process similar to that in the salary recommendation process, the M4 administrator may establish a bonus percentages based on position. The M4 administrator may also choose to move an individual name in the bonus tree shown in the GUI of FIG. 40. Following establishment of the bonus budget, the budget may be released to managers who in turn, may recommend bonus levels for their employees via the GUI of FIG. 41. The manager may be prompted to support recommendations that are above or below the budgeted bonus.

One of ordinary skill in the art would recognize that some or all of the GUIs of module M4 may be used to enter budget data. In addition to or alternatively, the GUIs may be presented in any order and may be saved for further edits in the future.

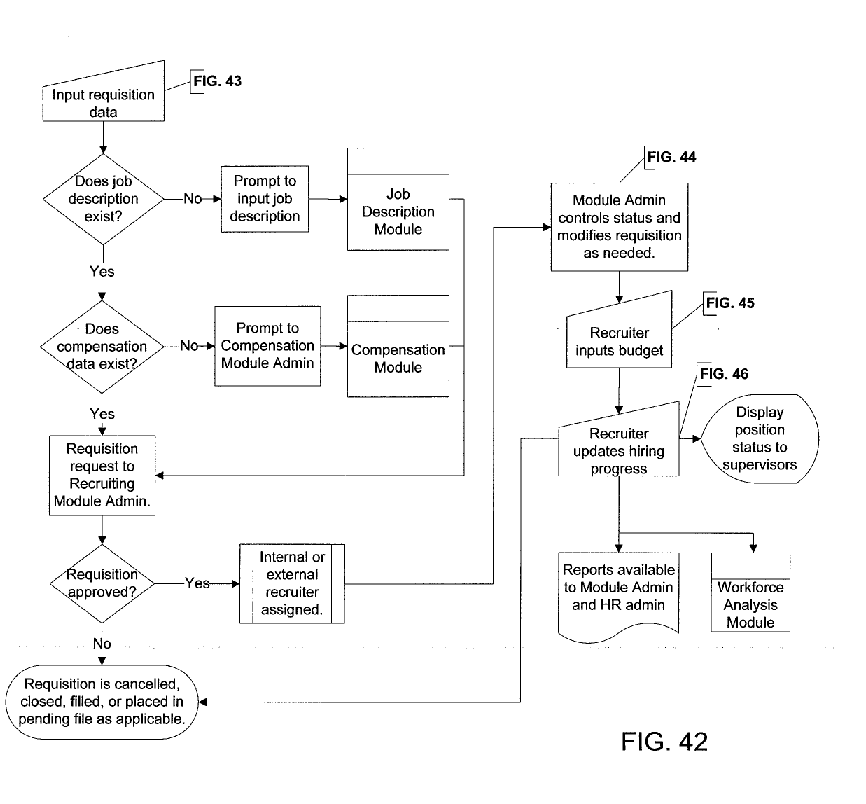

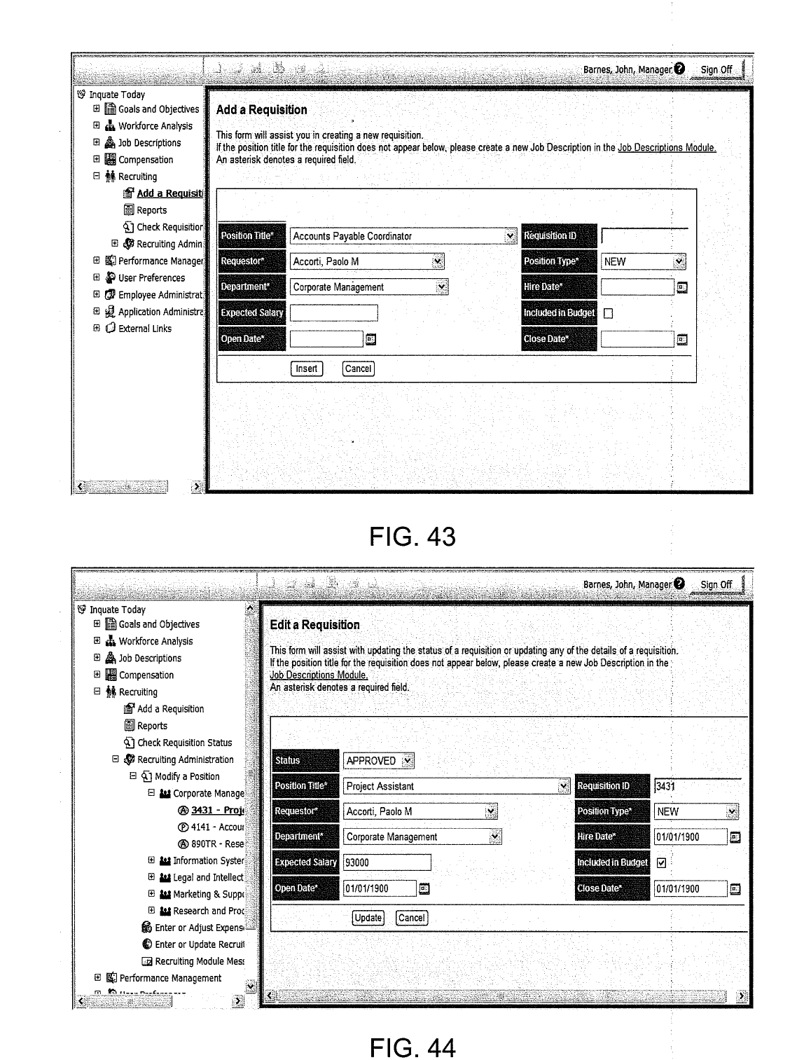

Turning to FIG. 42, a flowchart of the functions of the recruiting module M5, the supervisory user may request a position during the year using the GUI shown in FIG. 43. The title of the requested position may be recognized by compensation module M4 and a reflective salary may assigned to the position providing the position all ready exists. Alternatively, compensation data may be entered at this stage if the data does not exist. Job description data is drawn from job descriptions module M3 and may align with the requested position. Hiring activity, as entered in the GUI of FIG. 43 may be viewed by the hiring manager. The status of the position may be changed at any time by the M5 administrator. The M5 administrator may choose to modify, accept, reject, mark the position as pending, or cancel the position requisition using the GUI of FIG. 44. The M5 administrator may also add a new requisition using the GUI of FIG. 44.

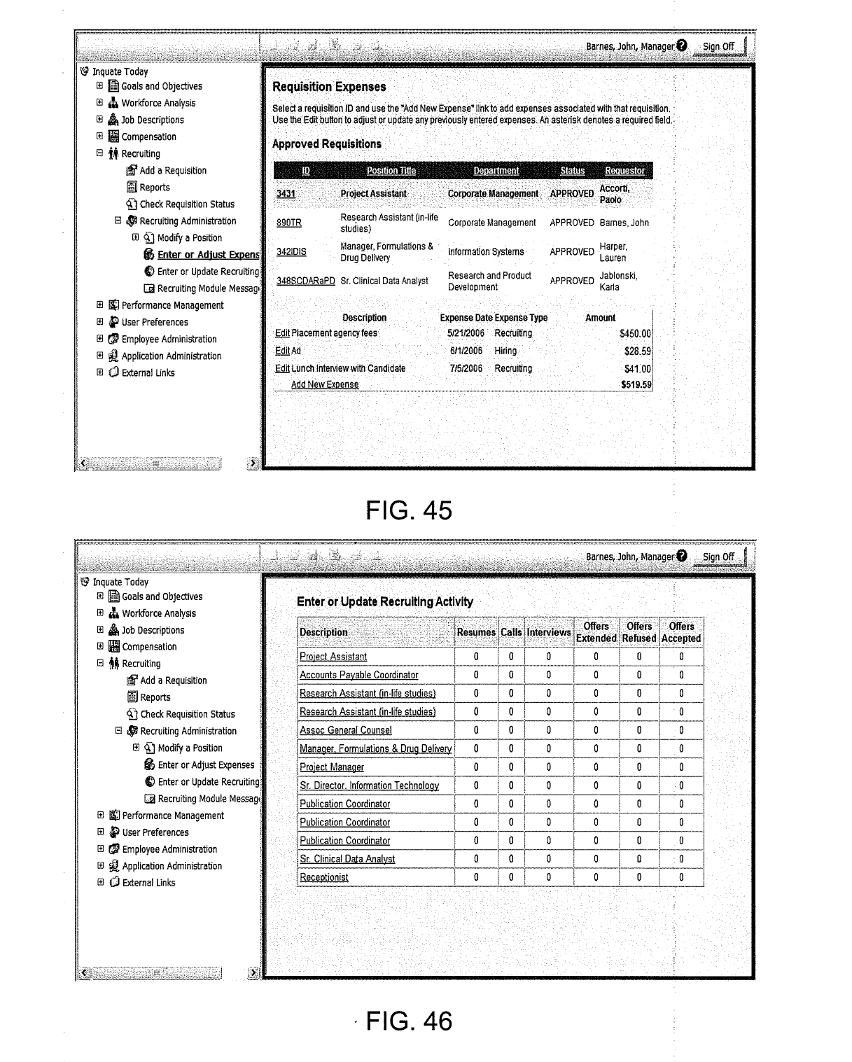

Additionally, recruiting costs, reflective of the company's accounting processes may be entered in the GUI of FIG. 45. Internal or external recruiters, pursuant to the security roles of FIG. 6, may be assigned to the position using the GUI of FIG. 46.

One of ordinary skill in the art would recognize that some or all of the GUIs of module M5 may be used to recruitment data. In addition to or alternatively, the GUIs may be presented in any order and may be saved for further edits in the future.

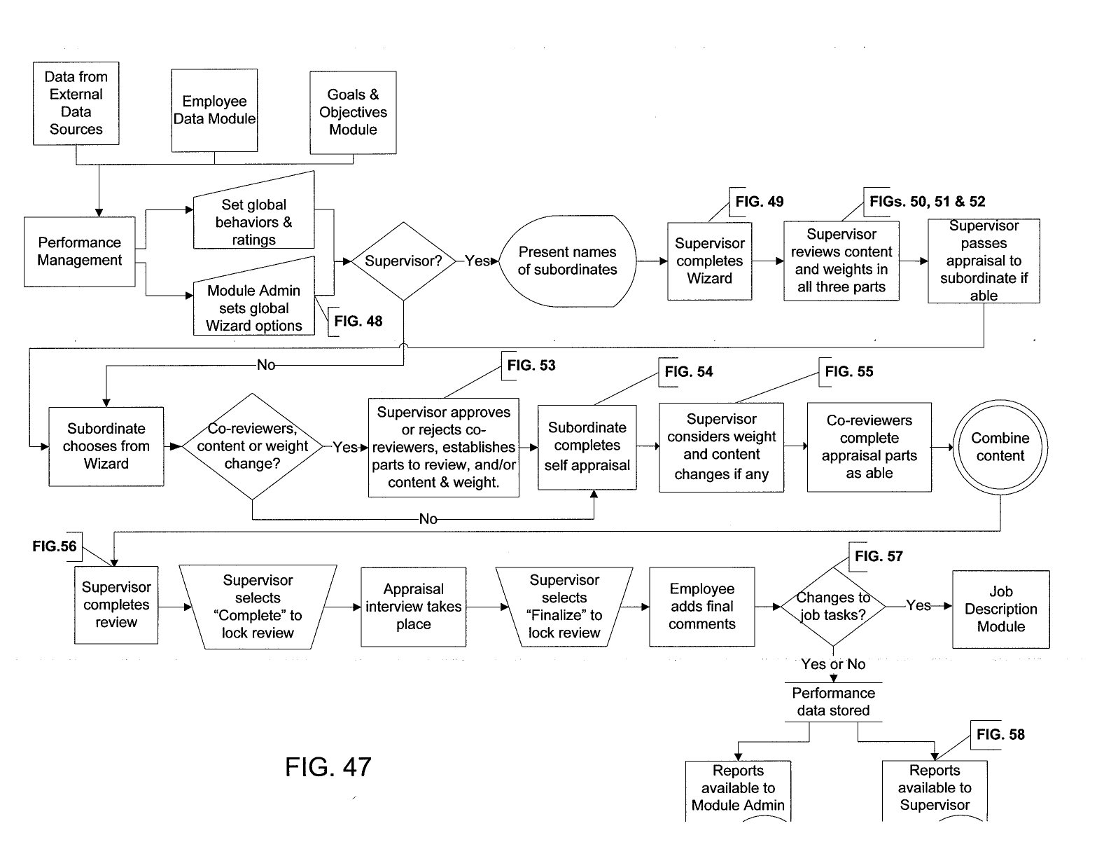

Turning to FIG. 47, a flowchart of the functions of the performance management module M6 is shown. In one embodiment, appraisal entered in the module M6 may include three parts and a conclusion section. All sections of the appraisal's content may be filled in automatically as a result of integration with the goals and objectives module M1 and the job descriptions module M3.

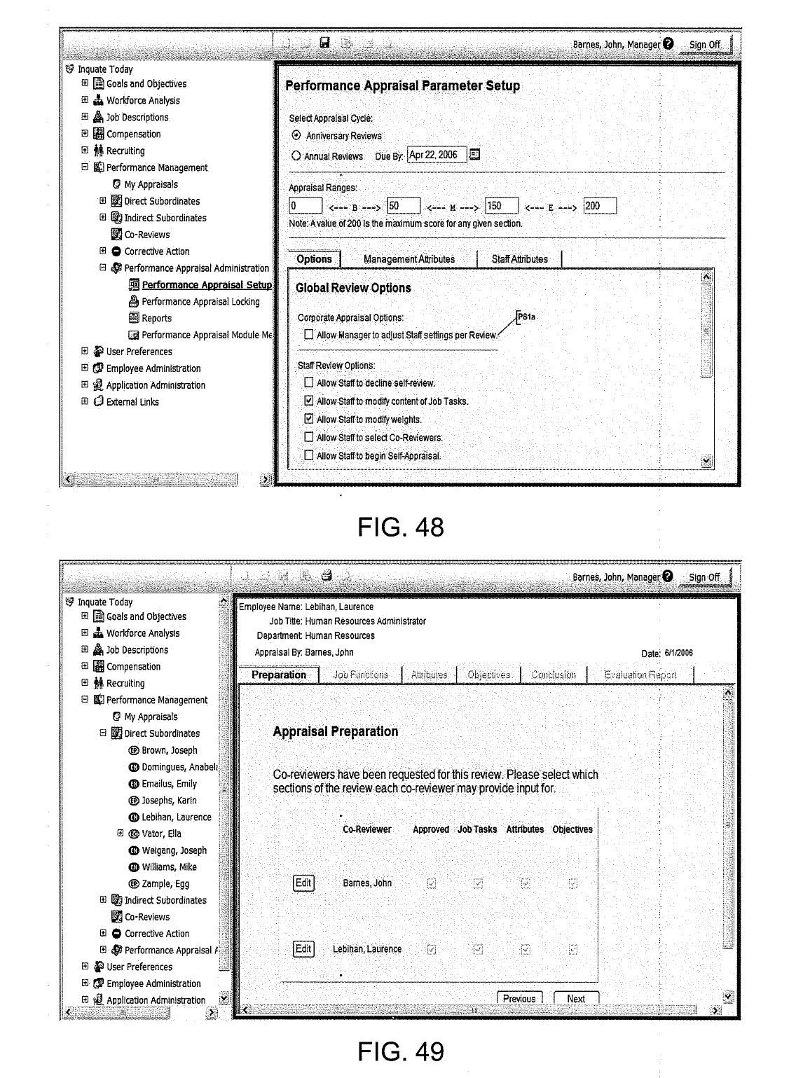

First, the M6 module administrator for the performance management module M6 may complete an appraisal setup procedure using the GUI shown in FIG. 48. The process may allow a universal establishment of either the employee's employment anniversary or a common review date.

The GUI of FIG. 48 may also allow the M6 administrator to select the process all appraisals within the organization may follow. Alternatively, the M6 administrator may allow each manager to select varying processes as desired. Following the choices made by the M6 administrator, which takes place at the end of a year or appraisal period, each manager may complete a setup wizard which establishes the process as established by the Module administrator. The M6 administrator may override the managers' ability to choose the process each subordinate's appraisal will follow by un-checking the box, PS1a, shown in FIG. 48.

The wizard process may allow the M6 administrator (or each manager as applicable) to choose from the following options:

Allow manager to adjust staff settings per review;

Allow staff to decline self-appraisal;

Allow staff to modify content of job tasks;

Allow staff to modify weights;

Allow staff to select co-reviewers;

Allow staff to begin self-appraisal;

Allow manager to prohibit self-appraisal;

Allow manager to select co-reviewers;

Allow manager to limit view of co-reviewers;

Allow manager to review out of cycle; and

Only allow managers as co-reviewers.

The wizard process may allow the implementation of a traditional appraisal, reflecting one-on-one interaction between the manager and his/her subordinate or unlimited selection of co-reviewers by either the manager or the subordinate or both the manager and the subordinate.

Referring to the GUI shown in FIG. 49, a supervisor may complete a wizard as allowed by the M6 administrator. The supervisor begins with establishing a date the appraisal review will take place. Dependent upon the choice made by the M6 administrator, proceeding through the wizard, the supervisor may able to determine whether to allow a co-reviewer to appraise the employee on a specific part or all of three of the parts of the appraisal. The supervisor may also make choices regarding whether the employee can recommend changes to the content and weight of the appraisal and whether the employee can choose co-reviewers. If the employee chooses co-reviewers, the supervisor may approve or reject the co-reviewers and he or she can allow the co-reviewers to have access to certain parts of the appraisal.

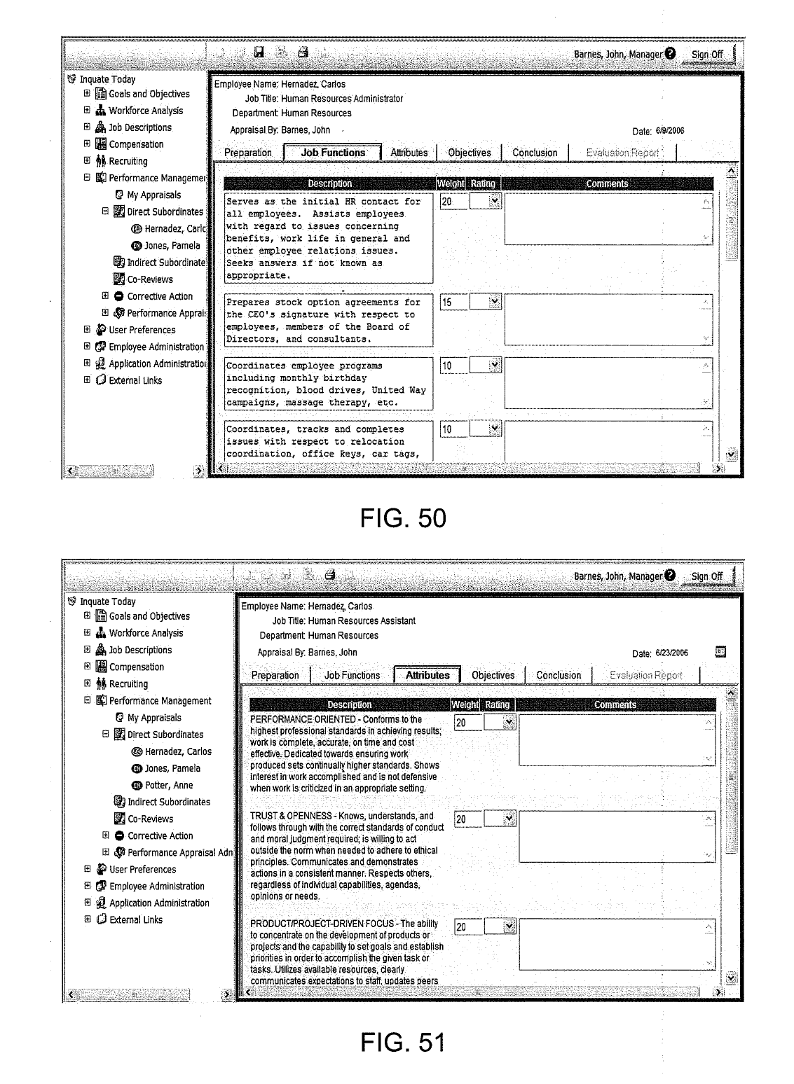

Following the wizard process, the supervisor may be ready to review the automated content and the weights of each item within each of the first three parts of the appraisal using the GUI of FIG. 50. The performance appraisal form includes four parts as follows:
Part One—Job Tasks or Accountabilities (referred to as accountabilities in performance management M6). Part One may automatically lists the job tasks for the incumbent (subordinate) following selection of the subordinate;
Part Two—Work Behaviors or Attributes (referred to as attributes in performance management M6). Part Two may list a number of personal attributes. These attributes may be established by the M6 administrator as agreed by the organization's leadership team or HR department;
Part Three—Completion of Objectives. Part Three appraises the employee's ability to complete objectives.; and
Part Four—Overall Score and Concluding Comments. The final Part of the performance management M6 is the overall weighting and concluding comments screen. Using this screen, the supervisor may apply weights to each of the three Parts as described above. Part Four may also be used by both the supervisor and the employee to add concluding comments. Additionally, an overall description of the employee's performance is included on the page as determined by the previous three Parts' weightings and ratings.

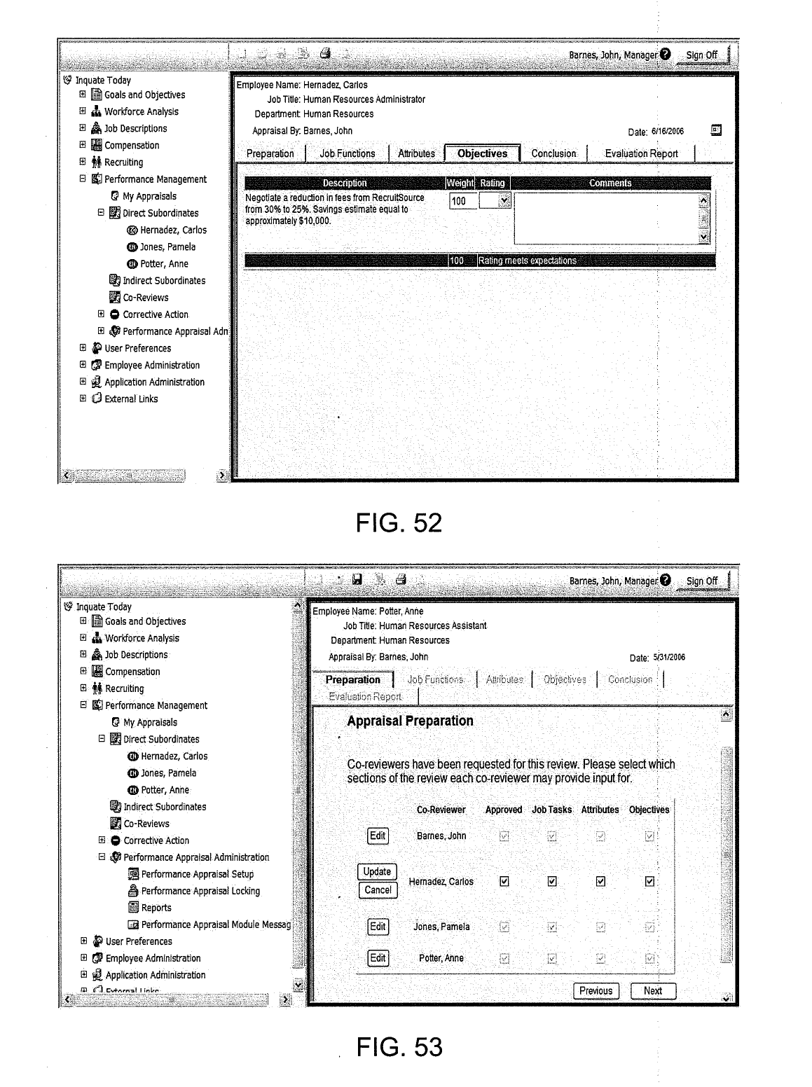

The content for the job functions section, part one, may be drawn from job descriptions module M3. Content for part two of the appraisal, attributes, FIG. 51, are drawn from the GUI of FIG. 48 and dependent upon whether the individual being appraised is a manager or non-manager. Objectives for each employee may be developed and recorded in the goals and objectives module M1. Additionally, the objectives may automatically be inserted into the objectives section of the performance appraisal for each respective employee, as shown in FIG. 52.

Once the content has been established, the manager may pas the appraisal on to the subordinate. Dependent upon the choices made in the initial setup as a result of the wizard process, the subordinate may choose to invite co-reviewers to participate in his or her appraisal (known as a 360 appraisal). The supervisor may choose to accept or reject the co-reviewers suggested by the subordinate. The supervisor may also choose to limit the accepted co-reviewers access to certain parts of the appraisal, using the GUI shown in FIG. 53.

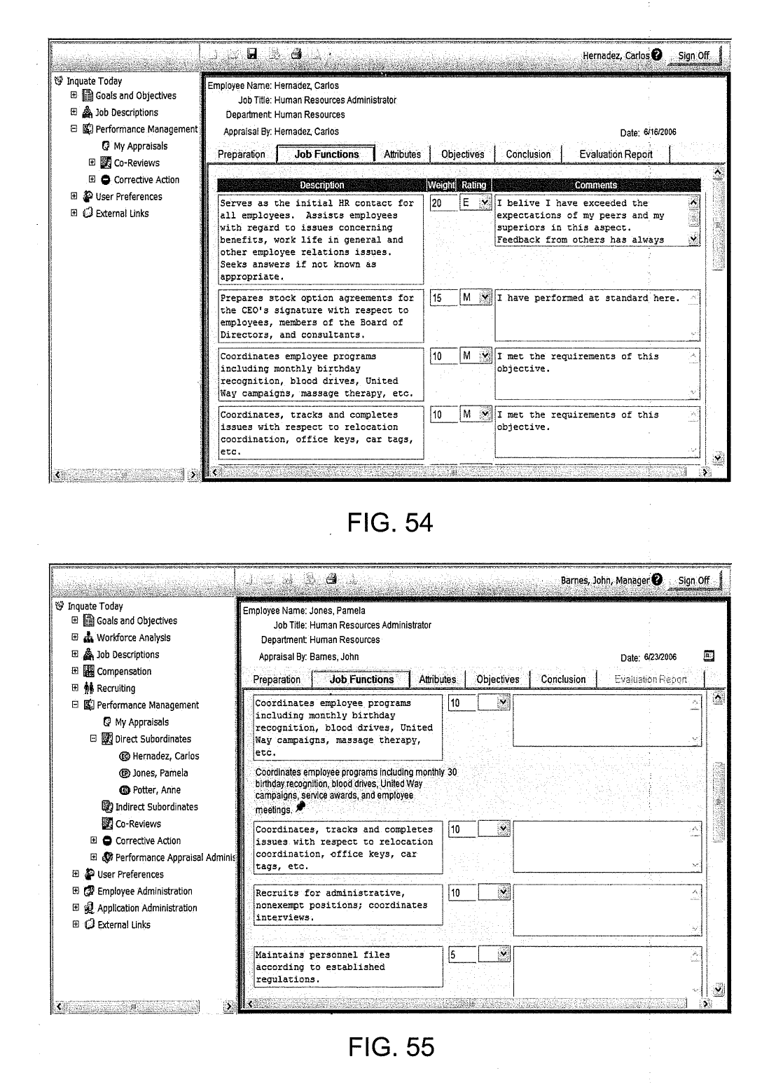

In some embodiments, the subordinate may continue or begin his or her self-appraisal using the GUI shown in FIG. 54. He or she may choose to recommend changes to content and/or weight pursuant to each item within the three parts. The supervisor may consider these recommendations and accept or reject them by selecting the “pin” icon to adopt the content change recommendations using the GUI shown in FIG. 55. The supervisor may consider the recommendation to the weight change (30% in FIG. 55) and overtype the existing weight, 10% in the example.

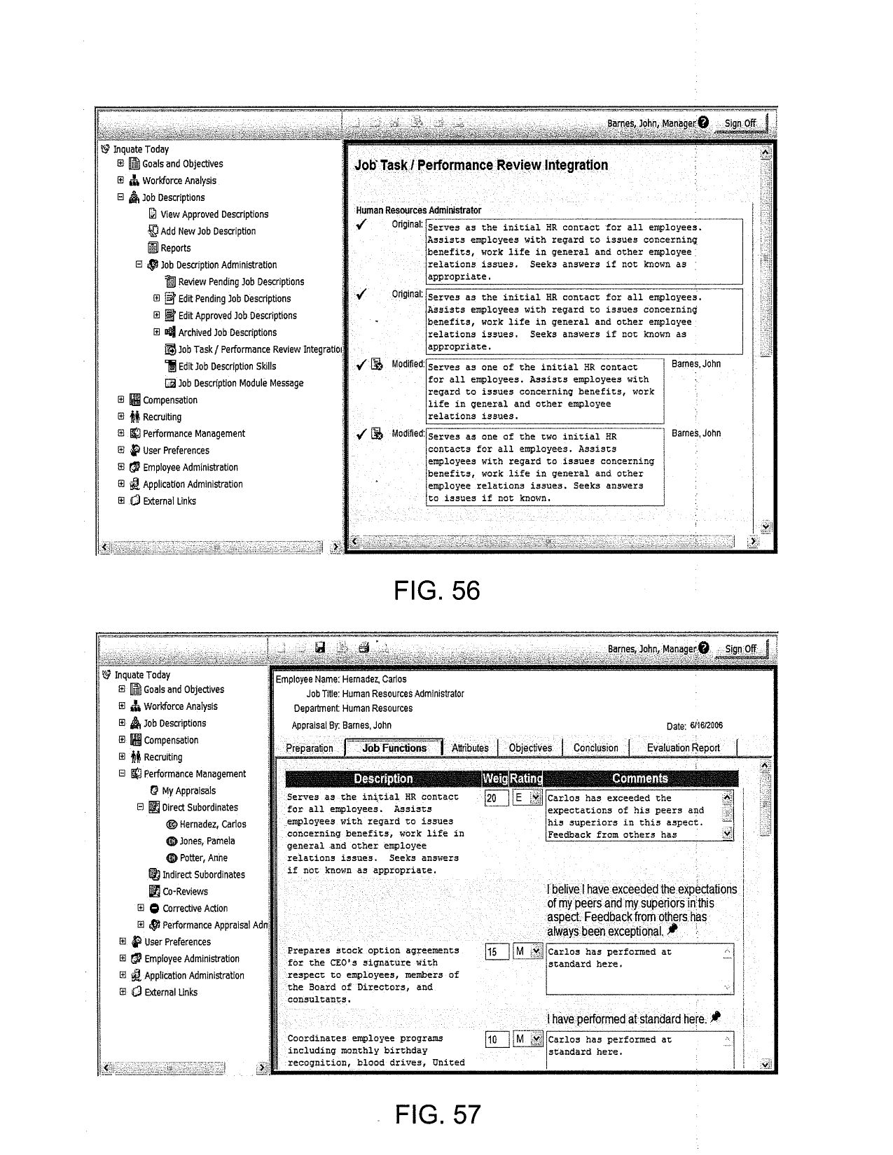

Regardless of whether the supervisor accepts the recommended changes to the content, the recommendations may be transferred to the job description module M3 for consideration by the M2 administrator using the GUI of FIG. 56. As such, the job descriptions may be updated at least annually. In one respect, the M6 administrator may choose to accept or reject the recommended changes to the job tasks regardless of the number of incumbents that recommend changes to the position's job tasks.

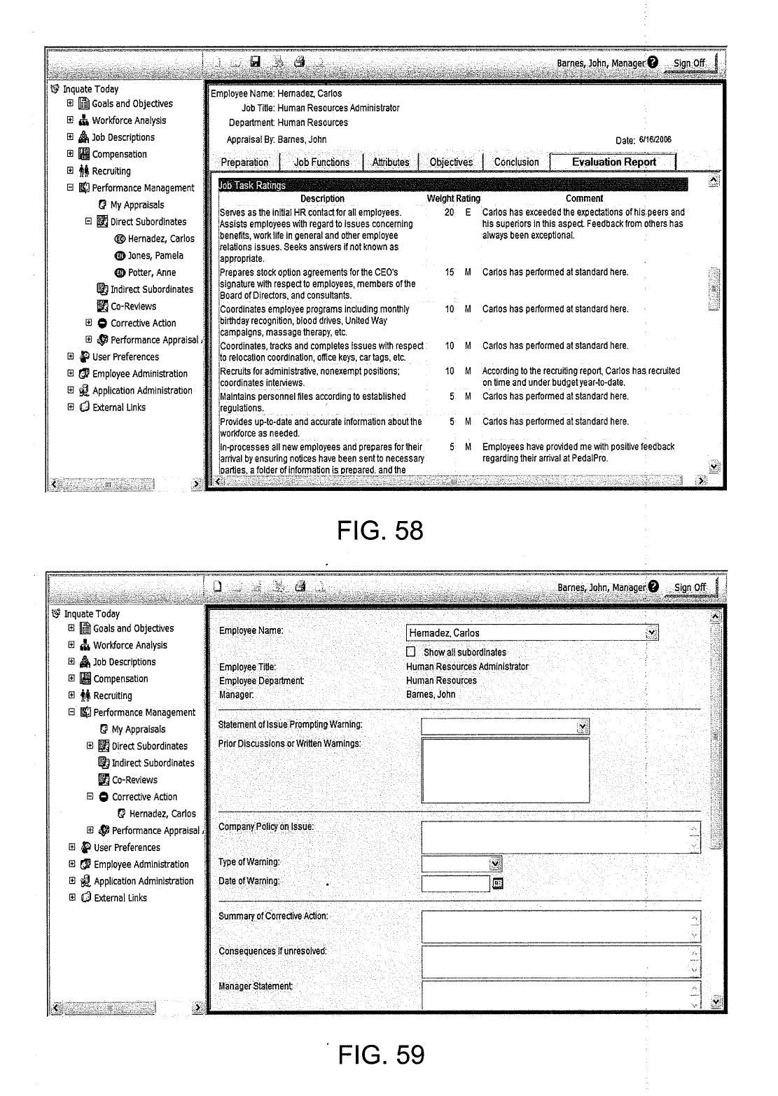

Providing the subordinate completes his or her self appraisal, the supervisor may choose to accept the subordinate's rating and/or the supportive comments using the GUI shown in FIG. 57. The supervisor may complete the appraisal's three parts and completes the conclusion section. Once all three parts and the conclusion sections are completed, the supervisor may choose the “Completed” button at the bottom of the conclusion section and the evaluation report may be generated, similar to the report shown in FIG. 58. Following the appraisal interview, the supervisor may chooses the “Finalize” button at the bottom of the conclusion section and the appraisal may locked and stored under each employee's name in a menu tree noted by the date the appraisal was completed.

It should be noted that senior management employees may view and comment on any of their subordinate employees' performance reviews. In addition, the M6 administrator may choose to view a variety of reports detailing the results of the appraisal process.

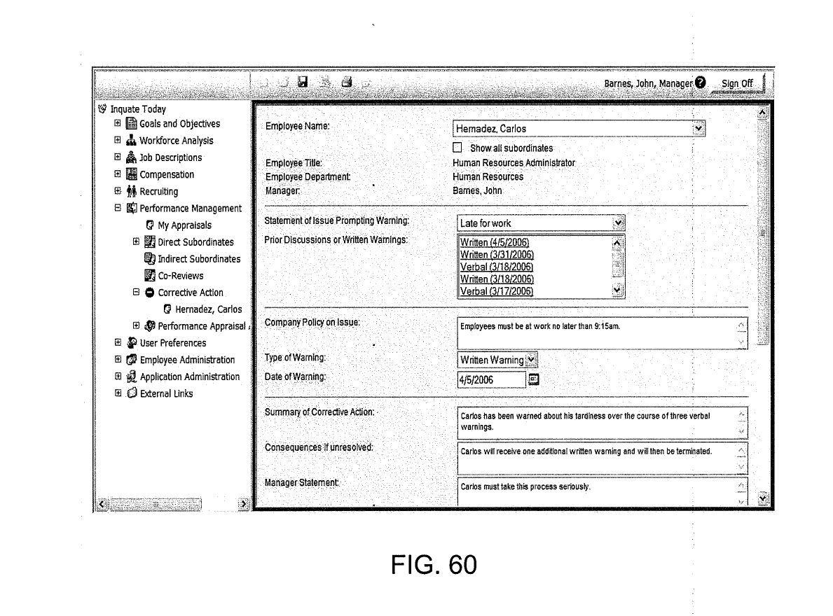

In some embodiments, M6's performance and/or behavior modification document recording process may allow a supervisor to record verbal warnings as well as written warnings. These warnings may be referenced at the time the performance appraisal is completed. Beginning with the GUI shown in FIG. 59, the supervisor may choose the name of an employee whose unsatisfactory behavior or performance requires action. If the employee has not previously received a warning, the supervisor may choose from the drop down list of names of his or her subordinates. A choice of a verbal or written warning may be presented to the supervisor. Following entry of the appropriate data using the GUI shown in FIG. 60, updates may be completed using the same view. The employee may be expected to comment and sign the warnings contained in the written warning process. Additional infractions reflecting the identical issue are subsequently recorded using the GUI shown in FIG. 59.

As is the case with module M1, supervisors senior to the immediate supervisor may view the information contained in M6's performance and/or behavior modification document recording process.

Following completion of the performance appraisals, the establishment of the company's goals may commence again and the human capital cycle continues into the succeeding year.

One of ordinary skill in the art would recognize that some or all of the GUIs of module M5 may be used to recruitment data. In addition to or alternatively, the GUIs may be presented in any order and may be saved for further edits in the future.

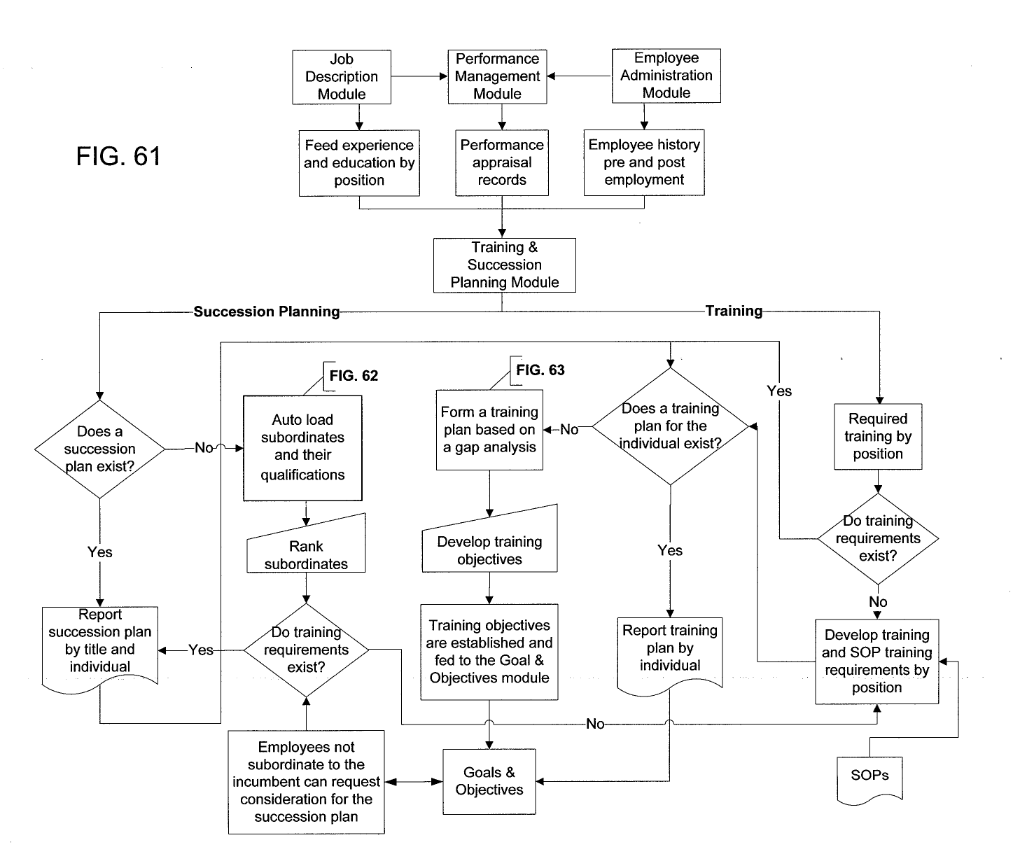

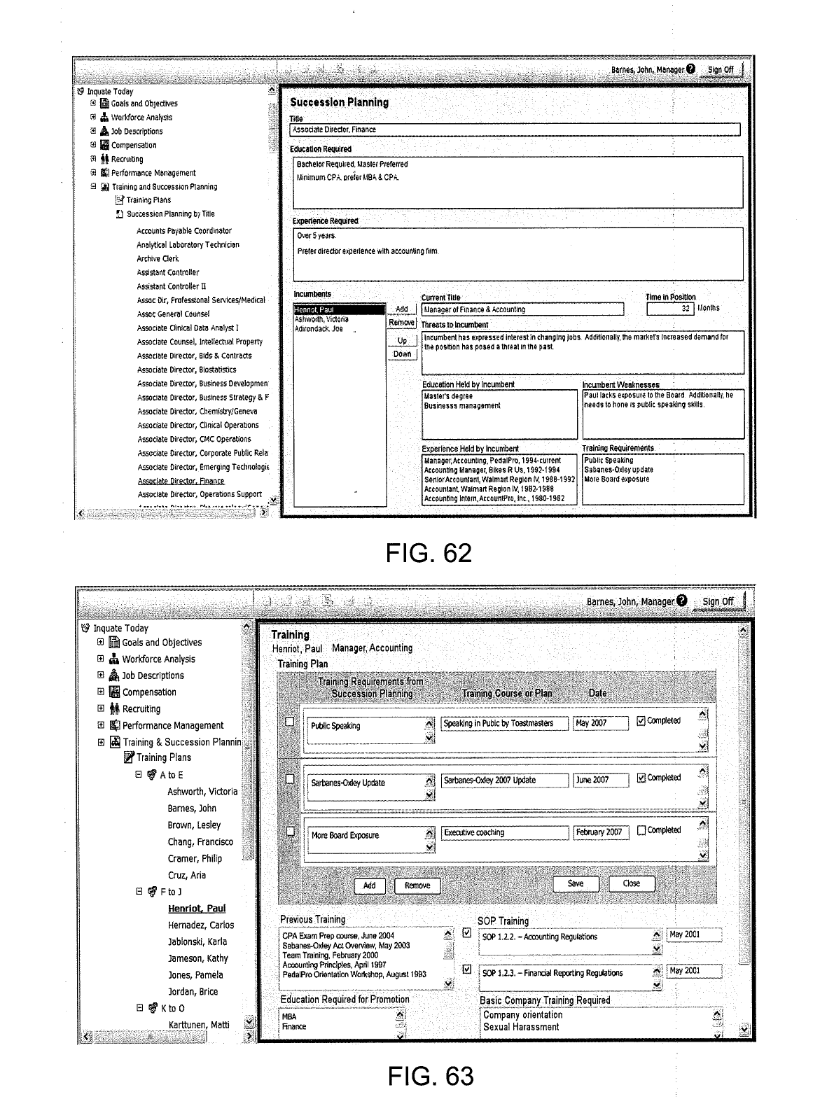

Turning to FIG. 61, a flowchart of the functions of the succession planning and training module M7 is shown. M7 may include two parts: succession planning and training plan development. Succession planning relies on information contained in job descriptions module M3, specifically education and experience requirements. Succession planning may be conducted by analyzing each position, the incumbents within each position, and their capabilities represented by a brief analysis of their weaknesses and threats to the continued employment of the incumbent (e.g., labor market conditions) using the GUI presented in FIG. 62. Performance management module M5 may provide information regarding the incumbent's performance capabilities and employee administration provides information regarding the employee's education and experience prior to employment with the company.

The other main function of module M7 may be to develop employee-specific training plans using the GUI shown in FIG. 63. The training plan may be customized for each employee and is thus accessible by each employee and his or her supervisor. In addition to training requirements resulting from the succession planning section of the module, the training section may incorporate training required pursuant to knowledge of Standard Operating Procedures (SOPs) and other company required training courses such as orientation training. Training objectives may then be included in goals and objectives module M1 and are may be treated as personal objectives with the intent of limiting the view of the training objectives to the employee and the employee's supervisory chain.

An employee may request consideration for advancement to a position outside the scope of his/her reporting path. The employee's name may subsequently be included in the succession plan pursuant to a specific title and a training plan is subsequently developed for the employee.

Techniques of this disclosure may be accomplished using any of a number of programming languages. Suitable languages include, but are not limited to, BASIC, FORTRAN, PASCAL, C, C++, C#, JAVA, HTML, XML, PERL, etc. An application configured to carry out the invention may be a stand-alone application, network based, or Internet based to allow easy, remote access. The application may be run on a personal computer, PDA, cell phone or any computing mechanism. Content from the application may be pushed to one or more client devices.

Computer code for implementing all or parts of this disclosure may be housed on any computer capable of reading such code as known in the art. For example, it may be housed on a computer file, a software package, a hard drive, a FLASH device, a USB device, a floppy disk, a tape, a CD-ROM, a DVD, a hole-punched card, an instrument, an ASIC, firmware, a “plug-in” for other software, web-based applications, RAM, ROM, etc. The computer code may be executable on any processor, e.g., any computing device capable of executing instructions for traversing a media stream. In one embodiment, the processor is a personal computer (e.g., a desktop or laptop computer operated by a user). In another embodiment, processor may be a personal digital assistant (PDA), a cellular phone, or other handheld computing device.

In some embodiments, the processor may be a networked device and may constitute a terminal device running software from a remote server, wired or wirelessly. Input from a source or other system components may be gathered through one or more known techniques such as a keyboard and/or mouse. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. The processor may use any type of monitor or screen known in the art, for displaying information. For example, a cathode ray tube (CRT) or liquid crystal display (LCD) can be used to display the multiple GUIs and reports of the present disclosure. One or more display panels may also constitute a display. In other embodiments, a traditional display may not be required, and the processor may operate through appropriate voice and/or key commands.

All of the methods disclosed and claimed can be made and executed without undue experimentation in light of the present disclosure. While the methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the disclosure as defined by the appended claims.

1. A computerized method for coordinating business functions of a company, the method comprising:
providing a goals and objectives module configured to establish and share goals and objectives of the company;
providing a workforce analysis module configured to determine a headcount and cost of personnel within the company;
providing a job description module configured to determine personnel job descriptions and requirements;
providing a compensation module configured to determine compensation factors;
providing a recruiting module configured to coordinate recruiting efforts;
providing a performance management module configured to analyze employee performance;
providing a succession planning and training module configured to develop employee training plan; and
generating a display for each of the modules, where the display provides a plurality of input prompts.

2. The method of claim 1, further comprising assigning customizable access to a user for each of the modules.

3. The method of claim 1, where the goals and objectives module is further configured to determine at least one employee responsible for each goal and objective.

4. The method of claim 3, where the goals and objectives module is further configured to determine a progress of the at least one employee.

5. The method of claim 1, where the workforce analysis module is further configured to determine the quantity and cost of new positions for the company.

6. The method of claim 5, where determining new positions comprises determining new positions based on a budget of the company.

7. The method of claim 1, where the compensation module is further configured to determine salary increases for personnel within an established budget.

8. The method of claim 1, where the compensation module is further configured to determine bonus amounts for personnel within an established budget.

9. The method of claim 1, where the recruiting module is further configured to process requests for additional positions.

10. The method of claim 9, where the recruiting module is further configured to track hiring activity of approved requests for additional or replacement positions.

11. The method of claim 1, where the recruiting module is further configured to track costs associated with hiring additional or replacement positions.

12. The method of claim 1, where the performance management module is further configured to determine changes to a position description.

13. The method of claim 1, where the succession planning and training module is further configured to analyze positions within the company.

14. The method of claim 1, where each module interacts with other modules.

15. The method of claim 1, where each module provides business metrics reporting capability.

16. A program storage device readable by a machine, tangibly embodying a program of instructions executable by the machine to perform the method steps of claim 1.

17. A computerized method for coordinating business functions of a company, the method comprising:
providing a goals and objectives module configured to establish and share goals and objectives of the company;
providing a job description module configured to determine personnel job descriptions and requirements;
providing a performance management module configured to analyze employee performance; and
generating a display for each of the modules, where the display provides a plurality of input prompts.

18. A computerized method for coordinating business functions of a company, the method comprising:
providing a goals and objectives module configured to establish and share goals and objectives of the company;
providing a succession planning and training module configured to develop employee training plan; and
generating a display for each of the modules, where the display provides a plurality of input prompts.

19. A computerized method for coordinating business functions of a company, the method comprising:
providing a workforce analysis module configured to determine a headcount and cost of personnel within the company;
providing a compensation module configured to determine compensation factors;
providing a recruiting module configured to coordinate recruiting efforts; and
generating a display for each of the modules, where the display provides a plurality of input prompts.

20. A system coordinating business functions of a company, the system comprising:
a computer comprising a processor configured to provide:
a goals module configured to establish goals and objectives of the company;
a workforce analysis module configured to determine a headcount of personnel within the company;
a job description module configured to develop personnel position descriptions;
a compensation module configured to determine compensation factors;
a recruiting module configured to coordinate recruiting efforts;
a performance management module configured to analyze employee performance;
a succession planning and training module configured to develop employee training plan
generating a display for each of the modules, where the display provides a plurality of input prompts;
a display coupled to the processor for displaying each module to a user; and
an input device configured to provide data from the user for each module.

21. The system of claim 20, where the data comprises data from external data sources.

22. The system of claim 20, where the data comprises data from sources within the company.

23. The system of claim 20, where the data comprises data from other modules.

24. The system of claim 20, further comprising an output device coupled to the computer for generating reports for each module.
